(19) United States
(12) Patent Application Publication
(10) Pub. No.: US 2025/0141628 A1
(43) Pub. Date: May 1, 2025

(54) METHODS, DEVICES, AND MEDIUM FOR COMMUNICATION

(71) Applicant: NEC CORPORATION, Tokyo (JP)

(72) Inventors: Yukai GAO, Beijing (CN); Peng GUAN, Beijing (CN); Lin LIANG, Beijing (CN); Gang WANG, Beijing (CN)

(73) Assignee: NEC CORPORATION, Tokyo (JP)

(21) Appl. No.: 18/836,531

(22) PCT Filed: Feb. 8, 2022
(86) PCT No.: PCT/CN2022/075471

§ 371 Date: Aug. 7, 2024

(51) Int. Cl. H04L 5/00; H04L 27/26

(52) U.S. Cl. CPC H04L 5/0051; H04L 27/2614

(57) ABSTRACT

Example embodiments of the present disclosure relate to an effective mechanism for reference signal (RS) configuration. In this solution, the terminal device determines at least one cyclic shift (CS) for an SRS transmission with four antenna ports, the at least one CS comprising: at least one first CS and at least one second CS, where the at least one second CS is different from the at least one first CS. Further, the terminal device transmits, to a network device and based on the at least one first CS and the at least one second CS, the SRS transmission over a comb-structure resource with a comb value of eight. In this way, the peak to average power ratio (PAPR) performance is improved.

### FIELD

Example embodiments of the present disclosure generally relate to the field of communication techniques and in particular, to methods, devices, and medium for reference signal (RS) configuration.

### BACKGROUND

Wireless communication networks are widely deployed and can support various types of service applications for terminal devices (i.e., user equipments, UEs). Many communication schemes have been proposed to support the rapidly increasing data traffic. For example, in order to meet the increasing wireless data traffic demand, a plurality of schemes have been proposed and implemented, where a multiple input multiple output (MIMO) technology is considered as one powerful scheme to achieve high data throughputs in the communication system. MIMO refers to the type of wireless transmission and reception scheme where both a transmitter and a receiver employ more than one antenna.

Generally speaking, an RS transmission is necessary for the wireless communication. Further, an RS that is used for demodulation of data or control signals is referred to as a demodulation (DM) RS, while an RS that is used for sounding an uplink channel is referred to as a sounding RS (SRS). In the 3rd-generation partnership project (3GPP) release 17, some enhancements for the RS transmission have been discussed. In the following 3GPP release 18, more discussions about the details and enhancements for the RS transmission are expected.

### SUMMARY

In general, example embodiments of the present disclosure provide a solution for RS configuration. Embodiments that do not fall under the scope of the claims, if any, are to be interpreted as examples useful for understanding various embodiments of the disclosure.

In a first aspect, there is provided a method of communication. The method comprises: determining, at a terminal device, at least one cyclic shift (CS) for an SRS transmission with four antenna ports, the at least one CS comprising: at least one first CS, at least one first CS, corresponding to a first set of the four antenna ports or a first set of REs configured for the SRS transmission, and at least one second CS, corresponding to a second set of the four antenna ports or a second set of REs configured for the SRS transmission, the at least one second CS being different from the at least one first CS. The method further comprises: transmitting, to a network device and based on the at least one first CS and the at least one second CS, the SRS transmission over a comb-structure resource with a comb value of eight.

In a second aspect, there is provided a method of communication. The method comprises: mapping, at a terminal device, eight antenna ports of an SRS resource to a comb-structure resource according to a comb value of the comb-structure resource, such that: at least two sets of REs based on at least two comb offset values are associated with different CSs or different CS sets, or at least two portions of the eight antenna ports are associated with different CSs or different CS sets. The method further comprises: transmitting, to a network device, an SRS transmission with the comb-structure resource.

In a third aspect, there is provided a method of communication. The method comprises: determining, at a terminal device, at least one sequence of time domain orthogonal cover code (TD-OCC) for a plurality of symbols, sequences of SRS antenna ports being used within a symbol period being the same, the symbol period corresponding to a number of OFDM symbols, wherein the number is same as a length of the TD-OCC. The method further comprises: transmitting, based on the determined at least one sequence of OCC, an SRS transmission over the plurality of symbols.

In a fourth aspect, there is provided a method of communication. The method comprises: mapping, at a terminal device, eight antenna ports of an SRS resource to a plurality of orthogonal frequency division multiplexing (OFDM) symbols by using at least one TD-OCC. The method further comprises: transmitting, to a network device, an SRS transmission over the plurality of OFDM symbols.

In a fifth aspect, there is provided a method of communication. The method comprises: determining, at a terminal device, at least one CS for a DMRS transmission type 1 with more than eight antenna ports, four CSs of the at least one CS being orthonormal to each other with a minimum orthonormal length of four or six. The method further comprises: performing, with a network device, the DMRS transmission.

In a sixth aspect, there is provided a method of communication. The method comprises: determining, at a terminal device, at least one frequency domain orthogonal cover code (FD-OCC) for a DMRS transmission type 2 with more than twelve antenna ports, a length of the at least one FD-OCC being four. The method further comprises: performing, with a network device, the DMRS transmission.

In a seventh aspect, there is provided a method of communication. The method comprises: receiving, at a terminal device and from a network device, a configuration for a DMRS transmission, indicating at least one of the following: information about a length of FD-OCC corresponding to at least one antenna port configured for the at least one antenna port, or information about antenna port group to be scheduled for the DMRS transmission. The method further comprises: performing the DRMS transmission with a network device based on the configuration.

In an eighth aspect, there is provided a method of communication. The method comprises: determining, at a network device, at least one CS for an SRS transmission with four antenna ports, the at least one CS comprising: at least one first CS, corresponding to a first set of the four antenna ports or a first set of REs configured for the SRS transmission, and at least one second CS, corresponding to a second set of the four antenna ports or a second set of REs configured for the SRS transmission, the at least one second CS being different from the at least one first CS. The method further comprises: receiving, from a terminal device and based on the at least one first CS and the at least one second CS, the SRS transmission over a comb-structure resource with a comb value of eight.

In a ninth aspect, there is provided a method of communication. The method comprises: mapping, at a network device, eight antenna ports of an SRS resource to a comb-structure resource according to a comb value of the comb-structure resource, such that: at least two sets of REs based on at least two comb offset values are associated with different CSs or different CS sets, or at least two portions of the eight antenna ports are associated with different CSs or different CS sets. The method further comprises: receiving, from a terminal device, an SRS transmission over the comb-structure resource.

In a tenth aspect, there is provided a method of communication. The method comprises: determining, at a network device, at least one sequence of TD-OCC for a plurality of symbols, sequences of SRS antenna ports being used within a symbol period being the same, the symbol period corresponding to a number of OFDM symbols, wherein the number is same as a length of the TD-OCC. The method further comprises: receiving, based on the determined at least one sequence of OCC, an SRS transmission over the plurality of symbols.

In an eleventh aspect, there is provided a method of communication. The method comprises: mapping, at a network device, eight antenna ports of an SRS resource to a plurality of OFDM symbols by using at least one TD-OCC. The method further comprises: receiving, from a terminal device, an SRS transmission over the plurality of OFDM symbols.

In a twelfth aspect, there is provided a method of communication. The method comprises: determining, at a network device, at least one CS for a DMRS transmission type 1 with more than eight antenna ports, four CSs of the at least one CS being orthonormal to each other with a minimum orthonormal length of four or six. The method further comprises: performing, with a terminal device, the DMRS transmission.

In a thirteenth aspect, there is provided a method of communication. The method comprises: determining, at a network device, at least one FD-OCC for a DMRS transmission type 2 with more than twelve antenna ports, a length of the at least one FD-OCC being four. The method further comprises: performing, with a terminal device, the DMRS transmission.

In a fourteenth aspect, there is provided a method of communication. The method comprises: transmitting, at a network device and to a terminal device, a configuration for a DMRS transmission, indicating at least one of the following: information about a length of FD-OCC corresponding to at least one antenna port configured for the at least one antenna port, or information about antenna port group to be scheduled for the DMRS transmission. The method further comprises: performing, the DRMS transmission with a terminal device based on the configuration.

In an fifteenth aspect, there is provided a terminal device. The terminal device includes a processing unit; and a memory coupled to the processing unit and storing instructions thereon, the instructions, when executed by the processing unit, causing the device to perform the method according to the first aspect.

In a sixteenth aspect, there is provided a terminal device. The terminal device includes a processing unit; and a memory coupled to the processing unit and storing instructions thereon, the instructions, when executed by the processing unit, causing the device to perform the method according to the second aspect.

In a seventeenth aspect, there is provided a terminal device. The terminal device includes a processing unit; and a memory coupled to the processing unit and storing instructions thereon, the instructions, when executed by the processing unit, causing the device to perform the method according to the third aspect.

In an eighteenth aspect, there is provided a terminal device. The terminal device includes a processing unit; and a memory coupled to the processing unit and storing instructions thereon, the instructions, when executed by the processing unit, causing the device to perform the method according to the fourth aspect.

In a nineteenth aspect, there is provided a terminal device. The terminal device includes a processing unit; and a memory coupled to the processing unit and storing instructions thereon, the instructions, when executed by the processing unit, causing the device to perform the method according to the fifth aspect.

In a twentieth aspect, there is provided a terminal device. The terminal device includes a processing unit; and a memory coupled to the processing unit and storing instructions thereon, the instructions, when executed by the processing unit, causing the device to perform the method according to the sixth aspect.

In a twenty-first aspect, there is provided a terminal device. The terminal device includes a processing unit; and a memory coupled to the processing unit and storing instructions thereon, the instructions, when executed by the processing unit, causing the device to perform the method according to the seventh aspect.

In a twenty-second aspect, there is provided a network device. The network device includes a processing unit; and a memory coupled to the processing unit and storing instructions thereon, the instructions, when executed by the processing unit, causing the device to perform the method according to the eighth aspect.

In a twenty-third aspect, there is provided a network device. The network device includes a processing unit; and a memory coupled to the processing unit and storing instructions thereon, the instructions, when executed by the processing unit, causing the device to perform the method according to the ninth aspect.

In a twenty-fourth aspect, there is provided a network device. The network device includes a processing unit; and a memory coupled to the processing unit and storing instructions thereon, the instructions, when executed by the processing unit, causing the device to perform the method according to the tenth aspect.

In a twenty-fifth aspect, there is provided a network device. The network device includes a processing unit; and a memory coupled to the processing unit and storing instructions thereon, the instructions, when executed by the processing unit, causing the device to perform the method according to the eleventh aspect.

In a twenty-sixth aspect, there is provided a network device. The network device includes a processing unit; and a memory coupled to the processing unit and storing instructions thereon, the instructions, when executed by the processing unit, causing the device to perform the method according to the twelfth aspect.

In a twenty-seventh aspect, there is provided a network device. The network device includes a processing unit; and a memory coupled to the processing unit and storing instructions thereon, the instructions, when executed by the processing unit, causing the device to perform the method according to the thirteenth aspect.

In a twenty-eighth aspect, there is provided a network device. The network device includes a processing unit; and a memory coupled to the processing unit and storing instructions thereon, the instructions, when executed by the processing unit, causing the device to perform the method according to the fourteenth aspect.

In a twenty-ninth aspect, there is provided a computer readable medium having instructions stored thereon, the instructions, when executed on at least one processor, causing the at least one processor to carry out the method according to any of the above first to fourteenth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2A illustrates a signaling chart illustrating a process for communication according to some embodiments of the present disclosure;

FIG. 2B illustrates an example of antenna port mapping according to some embodiments of the present disclosure;

FIG. 2C illustrates a complementary cumulative distribution function (CCDF) of the PAPR for 4-port SRS transmission;

FIG. 3A illustrates an example of antenna port mapping for comb value of 2 according to some embodiments of the present disclosure;

FIG. 3B illustrates another example of antenna port mapping for comb value of 2 according to some embodiments of the present disclosure;

FIG. 3C illustrates an example of antenna port mapping for comb value of 4 according to some embodiments of the present disclosure;

FIG. 3D illustrates an example of antenna port mapping for comb value of 8 according to some embodiments of the present disclosure;

FIG. 4A illustrates an example of antenna port mapping for a length of TD-OCC being 2 according to some embodiments of the present disclosure;

FIG. 4B illustrates an example of antenna port mapping for a length of TD-OCC being 4 according to some embodiments of the present disclosure;

FIG. 5 illustrates an example method performed by the terminal device according to some embodiments of the present disclosure;

FIG. 6 illustrates an example method performed by the terminal device according to some embodiments of the present disclosure;

FIG. 7 illustrates an example method performed by the terminal device according to some embodiments of the present disclosure;

FIG. 8 illustrates an example method performed by the terminal device according to some embodiments of the present disclosure;

FIG. 9 illustrates an example method performed by the terminal device according to some embodiments of the present disclosure;

FIG. 10 illustrates an example method performed by the terminal device according to some embodiments of the present disclosure;

FIG. 11 illustrates an example method performed by the terminal device according to some embodiments of the present disclosure;

FIG. 12 illustrates an example method performed by the network device according to some embodiments of the present disclosure;

FIG. 13 illustrates an example method performed by the network device according to some embodiments of the present disclosure;

FIG. 14 illustrates an example method performed by the network device according to some embodiments of the present disclosure;

FIG. 15 illustrates an example method performed by the network device according to some embodiments of the present disclosure;

FIG. 16 illustrates an example method performed by the network device according to some embodiments of the present disclosure;

FIG. 17 illustrates an example method performed by the network device according to some embodiments of the present disclosure;

FIG. 18 illustrates an example method performed by the network device according to some embodiments of the present disclosure; and

FIG. 19 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As discussed above, the RS transmission is necessary for the wireless communication. During 3GPP release 17, it has been proposed that a comb value for SRS may be up to 8 (i.e., K_{TC}=8). Further, it has been agreed that in case that the comb value for SRS is 8, the maximum number of CS values n_{SRS}^{cs,max} (also referred to as Max_CS) for SRS 4-port SRS (i.e. port #0˜#3. For example, Nₐₚ^{SRS}=4) transmission is six. In this event, port #0 and port #2 map to REs based on a first comb offset, and the CSs for port #0 and port #2 are n_CS and (n_CS+3) mod 6, respectively, while port #1 and port #3 map to REs based on a second comb offset, and the CSs for port #1 and port #3 are n_CS and (n_CS+3) mod 6, respectively. Parameters n_CS (e.g. n_{SRS}^{cs}) and the comb offsets (e.g. k_{TC}^{(p}^{ᵢ}⁾, and pᵢ is the indication of antenna port, i ∈ {0, 1, . . . Nₐₚ^{SRS}-1}) are calculated based on below Equations (1) and (2).

$${n}_{SRS}^{cs , i} = \{ \begin{matrix}( {n}_{CRS}^{cs} + \frac{{n}_{SRS}^{cs , max} ⌊ ( {p}_{i} - 1000 ) / 2 ⌋}{{N}_{ap}^{SRS} / 2} ) mod {n}_{SRS}^{cs , max} & if {N}_{ap}^{SRS} = 4 and {n}_{SRS}^{cs , max} = 6 \\ ( {n}_{CRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix} \qquad Equation ( 1 )$$

$${k}_{TC}^{( {p}_{i} )} = \{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs} ∈ \{ {n}_{SRS}^{cs , max} / 2 , … , {n}_{SRS}^{cs , max} - 1 \} \\ {\overline{k}}_{TC} & otherwise\end{matrix} \qquad Equation ( 2 )$$

where n_{SRS}^{cs} ∈{0,1, . . . , n_{SRS}^{cs,max}-1} is contained in the higher layer parameter transmissionComb;
where the transmission comb offset k̅_{TC}∈{0,1, . . . , K_{TC}-1} is contained in the higher-layer parameter transmissionComb in the SRS-Resource information element (IE) or the SRS-PosResource IE.

Then the CS αᵢ for antenna port pᵢ is given as below Equation (3).

$${α}_{i} = 2 π \frac{{n}_{SRS}^{cs , i}}{{n}_{SRS}^{cs , max}} \qquad Equation ( 3 )$$

As the maximum number of CS values for 4-port SRS transmission is 6, the CSs values for Ports #0 and #2 and the CSs values for Ports #1 and #3 are the same, which causes that the peak to average power ratio (PAPR) performance is degraded. Thus, it is expected that the PAPR performance for the 4-port SRS transmission over a comb-structure resource with a comb value of 8 may be improved.

Further, in release 17, some enhancements for the SRS and DMRS transmission have been discussed. For example, some targets haven been proposed as below:
Enhancement on SRS, targeting both frequency range (FR) 1 and FR2:
   Specify SRS switching for up to 8 antennas;
   Evaluate and, if needed, specify the following mechanism(s) to enhance SRS capacity and/or coverage: SRS time bundling, increased SRS repetition, partial sounding across frequency.
Enhancement on DMRS, targeting both FR 1 and FR2:
   Study, and if justified, specify larger number of orthogonal DMRS ports for downlink and uplink MU-MIMO (without increasing the DMRS overhead),
   Up to 24 orthogonal DMRS ports, where for each applicable DMRS type, the maximum number of orthogonal ports is doubled for both single-symbol DMRS and double-symbol DMRS.

In a nutshell, the number of antenna ports for both SRS and DMRS transmission is increased. In this event, the configuration for the SRS and DMRS transmission with the increased antenna port number is desirable to be discussed.

According to some embodiments of the present disclosure, the configuration for the RS (including SRS and DMRS) is increased, and at least some of the above issues are addressed.

It should be understood that the above illustrated issues are only for the purpose of illustration without suggesting any limitations. Both of the pending issues and the issues addressed by the present disclosure also are not limited to the above illustrated issues.

For ease of discussion, some parameters used in the following description are listed as below:
K_{TC}: refers to a length of a comb-structure resource or refers to transmission comb number/value; also be represented as K_TC; For example, the value of K_{TC} may be one of {1, 2, 4, 8, 12};
k̅_{TC}∈{0,1, . . . , K_{TC}-1}: refers to a configured transmission comb offset, contained in the higher-layer parameter transmissionComb in the SRS-Resource information element (IE) or the SRS-PosResource IE;
pᵢ: refers to index of antenna port;
Nₒₚ^{SRS}: a number of antenna ports; For example, the value of Nₒₚ^{SRS} may be one of {1, 2, 4, 8, 12};
n_{SRS}^{cs,max}: a maximum number of CS values; also be represented as Max_CS; For example, the value of n_{SRS}^{cs,max} may be one of {6, 8, 12};
TD: a length of the TD-OCC; For example, the value of TD may be one of {2, 4, 8};
N_{symb}^{slot} refers to a number of OFDM symbols in a slot; For example, the value of N_{symb}^{slot} may be at least {12, 14};
l₀: refers to the starting position in the time domain given by l₀=N_{symb}^{slot}-1-l_{offset};
l′ ∈ {0,1, . . . , N_{symb}^{SRS}-1}: refers to a symbol number/index within an SRS resource;
c(i): refers to a pseudo-random sequence;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
μ: refers to subcarrier spacing configuration; For example, the value of ρ may be one of {0, 1, 2, 3, 4, 5, 6}; For example, μ=0 refers to subcarrier spacing 15 kHz; μ=1 refers to subcarrier spacing 30 kHz; μ=2 refers to subcarrier spacing 60 kHz; μ=3 refers to subcarrier spacing 120 kHz; μ=4 refers to subcarrier spacing 240 kHz; μ=5 refers to subcarrier spacing 480 kHz; μ=6 refers to subcarrier spacing 960 kHz;
Nₛₗₒₜ^{frame,μ} refers to number of slots per frame for subcarrier spacing configuration μ; For example, the value of Nₛₗₒₜ^{frame,μ} may be one of {10, 20, 40, 80, 160, 320, 640}; In one specific example embodiments, the value of Nₛₗₒₜ^{frame,μ} may be one of {10, 20, 40, 80, 160, 320, 640} for subcarrier spacing μ={0, 1, 2, 3, 4, 5, 6} respectively;
n_{s,f}^{μ} ∈ {0, . . . , Nₛₗₒₜ^{frame,μ}-1} refers to a number/index of slot within a frame for subcarrier spacing configuration μ;
M_{sc,b}^{SRS}: refers to the length of the SRS sequence; and
N_{sc}^{RB}=12: refers to a number of subcarriers within a resource block (RB).

In this present disclosure, some terms may refer to same or similar physical meaning and may be used interchangeably. Some exemplary examples are listed as below.
The terms “resource block”, “RB”, “physical resource block” and “PRB” can be used interchangeably;
The terms “symbol” and “OFDM symbol” can be used interchangeably.

### Example Environment

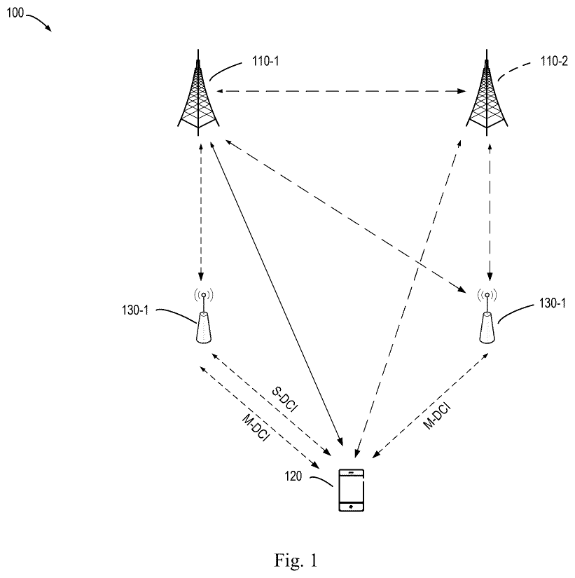

FIG. 1 illustrates an example communication network 100 in which embodiments of the present disclosure can be implemented. The communication network 100 includes a network device 110-1 and an optionally network device 110-2 (collectively or individually referred to as network devices 110). The network device 110 can provide services to a terminal device 120. For purpose of discussion, the network device 110-1 is referred to as the first network device 110-1, and the network device 110-2 is referred to as the second network device 110-2. Further, the first network device 101-1 and the second network device 110-1 can communicate with each other.

In the environment 100, a link from the network devices 110 (such as, a first network device 110-1 or the second network device 110-2) to the terminal device 120 is referred to as a downlink, while a link from the terminal device 120 to the network devices 110 (such as, a first network device 110-1 or the second network device 110-2) is referred to as an uplink. In downlink, the first network device 110-1 or the second network device 120-1 is a transmitting (TX) device (or a transmitter) and the terminal device 120 is a receiving (RX) device (or a receiver). In uplink, the terminal device 120 is a transmitting TX device (or a transmitter) and the first network device 110-1 or the second network device 110-2 is a RX device (or a receiver).

In some embodiments, the network device(s) 110 and the terminal device 120 may communicate with direct links/channels.

Further, in the specific example of FIG. 1, a multi-TRP transmission also is supported. As illustrated in FIG. 1, the terminal device 120 may communicate with two TRPs, i.e., the TRPs 130-1 and 130-2 (collectively or individually referred to as TRP 130). For purpose of discussion, the TRP 130-1 is referred to as the first TRP 130-1, and the TRP 130-2 is referred to as the second TRP 130-2.

In addition, in order to support multi-TRP and/or multi-panel, the network device 110 may be equipped with one or more TRPs. For example, the network device 110 may be coupled with multiple TRPs in different geographical locations to achieve better coverage. In one specific example embodiment, the first network device 110-1 is equipped with the first TRP 130-1 and the second TRP 130-2. Alternatively, in another specific example embodiment, the first network device 110-1 and the second network device 110-2 are equipped with the first TRP 130-1 and the second 130-2, respectively.

Further, both a single TRP mode transmission and multi-TRP transmission are supported by the specific example of FIG. 1. Specifically, in case of the single TRP mode, the terminal device 120 communicates with the network 100 via the first TRP 130-1/second TRP 130-2. Alternatively, in case of the multi-TRP mode, the terminal device 120 communicates with the network 100 via both of the first TRP 130-1 and the second TRP 130-2.

Further, the network device(s) 110 may provide one or more serving cells and the first TRP 130-1 and the second TRP 130-2 may be included in a same serving cell or different serving cells. In other words, both an inter-cell transmission and an intra-cell transmission are supported by the specific example of FIG. 1.

Further, in the specific example of FIG. 1, when a single DCI mode is applied, the terminal device 120 receives a single DCI (S-DCI) message from the first TRP 130-1. It should be understood that the single DCI message also may be received from the second TRP 130-2. Alternatively, when a multi-DCI mode is applied, the terminal device 120 receives two DCI messages (M-DCI) from the first TRP 130-1 and the second TRP 130-2, respectively.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices (i.e., the terminal device 120, the network device 110 and the TRP 130) and their connection relationships and types shown in FIG. 1 are only for the purpose of illustration without suggesting any limitation. The communication network 100 may include any suitable numbers of devices adapted for implementing embodiments of the present disclosure.

### Example Processes

It should be understood that although feature(s)/operation(s) are discussed in specific example embodiments separately, unless clearly indicated to the contrary, these feature(s)/operation(s) described in different example embodiments may be used in any suitable combination.

Further, it is to be understood that the operations at the terminal device 120 and the network device 110 should be coordinated. In other words, the network device 110 and the terminal device 120 should have common understanding about configuration, parameters and so on. Such common understanding may be implemented by any suitable interactions between the network device 110 and the terminal device 120 or both the network device 110 and the terminal device 120 applying the same rule/policy. In the following, although some operations are described from a perspective of the terminal device 120, it is to be understood that the corresponding operations should be performed by the network device 110. Similarly, although some operations are described from a perspective of the network device 110, it is to be understood that the corresponding operations should be performed by the terminal device 120. Merely for brevity, some of the same or similar contents are omitted here.

In addition, in the following description, some interactions are performed among the terminal device 120 and the network device 110. It is to be understood that the interactions may be implemented either in one single signaling/message or multiple signaling/messages, including system information (SI), RRC message, downlink control information (DCI) message, uplink control information (UCI) message, media access control (MAC) control element (CE) and so on. The present disclosure is not limited in this regard.

Example processes for different scenarios will be discussed as below.

### Example Processes for 4-Port SRS Transmission

As discussed above, due to the limitation of the maximum number of CS values, the PAPR performance for the 4-port SRS transmission is degraded. According to some example embodiments of the present disclosure, the CS configuration for the 4-port SRS transmission is improved and the PAPR performance is increased thereby.

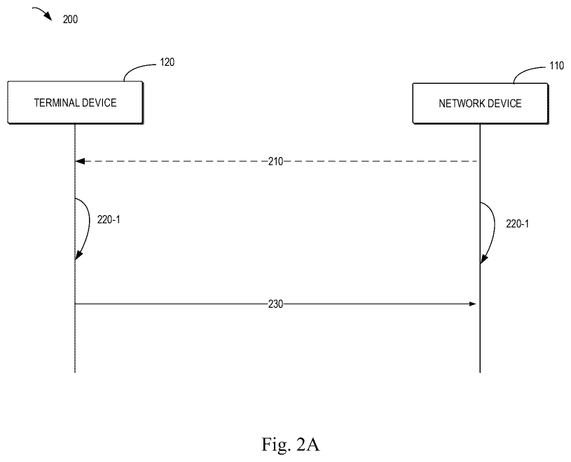

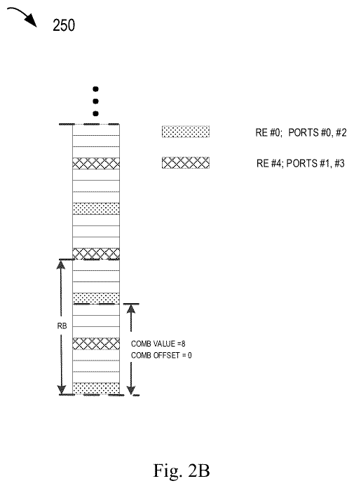

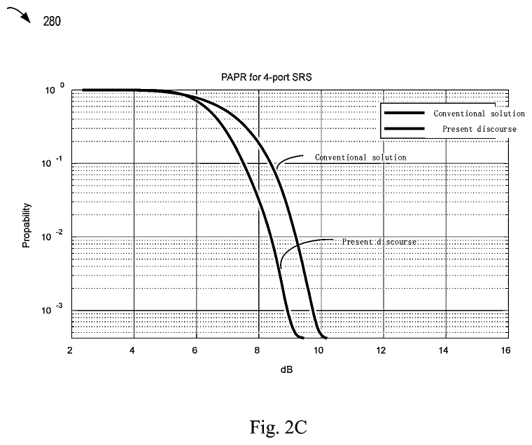

Principle and implementations of the present disclosure will be described in detail below with reference to FIGS. 2A and 2B. FIG. 2A shows a signaling chart illustrating a process 200 of communication according to some example embodiments of the present disclosure while FIG. 2B illustrates an example of antenna port mapping 250 according to some embodiments of the present disclosure. For the purpose of discussion, the process 200 will be described with reference to FIG. 1. The process 200 may involve the terminal device 120 and the network device 110.

In the specific example of FIGS. 2A and 2B, an SRS transmission with four antenna ports (ports #0˜#3) is configured over a comb-structure resource with a comb value of 8.

In operation, the terminal device 120 determines 220-1 at least one CS for the 4-port SRS transmission, while the network device 110 determines 220-2 the at least one CS accordingly. Based on the determined at least one CS, the terminal device 120 transmits 230 the SRS transmission to the network device 110.

In particular, the at least one CS comprises at least one first CS and at least one second CS, where the at least one first CS corresponds to a first set of the four antenna ports (or at least one first RE configured for the SRS transmission), while the at least one second CS corresponds to a second set of the four antenna ports (or at least one second RE configured for the SRS transmission). According to some example embodiments of the present disclosure, the at least one second CS is different from the at least one first CS.

As illustrated in FIG. 2B, a comb value (K_{TC}) for the comb-structure resource is 8, i.e., K_{TC}=8, and a comb offset is configured to be 0, i.e., k̅_{TC}=0. Ports #0, #2 are mapped to REs based on the comb offset k̅_{TC}, and ports #1, #3 are mapped to REs based on a comb offset (k̅_{TC}+K_{TC}/2) mod K_{TC}. In the conventional solution, port #0 and port #1 are associated with same CS values, and port #2 and port #3 are associated with same CS values. Different from the conventional solution, according to some example embodiments of the present disclosure, the at least one first CS determined for the first set of the four antenna ports (i.e., ports #0, #2; corresponding to RE #0) is different from the at least one second CS determined for the second set of the four antenna ports (i.e., ports #1, #3; corresponding to RE #4). For example, the CS for port #0 is different from the CS for port #1. For another example, the CS for port #2 is different from the CS for port #3.

In this way, the PAPR performance for 4-port SRS is enhanced. Reference is now made to FIG. 2C, which illustrates a CCDF of the PAPR 280 for 4-port SRS transmission. As illustrated in FIG. 2C, the PAPR performance is enhanced compared with the conventional solution.

In some embodiments, the terminal device 120 (and the network device 110) determines an offset value for calculating either the at least one first CS or the at least one second CS, such that the at least one second CS is different with the at least one first CS.

In some embodiments, the offset value may be defined to be a default value. Specifically, the default value may be stipulated by a wireless organization (such as, 3GPP), or a network operator, a service provider and so on. Alternatively, the offset value is configured by the network device 110. As illustrated in FIG. 2A, the network device 110 transmits 210 a configuration indicating the offset to the terminal device 120, via such as, RRC message, DCI message, MAC CE message or any suitable message.

In one specific example embodiment, port #0 and port #2 map to REs based on a first comb offset (e.g. k̅_{TC}), and the CSs for port #0 and port #2 are n_CS and (n_CS+3) mod 6, respectively, while port #1 and port #3 map to REs based on a second comb offset (e.g. (k̅_{TC}+K_{TC}/2) mod K_{TC}), and the CSs for port #1 and port #3 are (n_CS+cs_offset) and (n_CS+3+cs_offset) mod 6, respectively. For example, the value of n_CS may be one of {0, 1, 2, 3, 4, 5}. For example, the value of cs_offset may be 1 or 2. In one specific example embodiment, parameters n_CS may be calculated based on below Equation (4).

$${n}_{SRS}^{cs , i} = \{ \begin{matrix}( {n}_{CRS}^{cs} + \frac{{n}_{SRS}^{cs , max} ⌊ ( {p}_{i} - 1000 ) / 2 ⌋}{{N}_{ap}^{SRS} / 2} + offset ) mod {n}_{SRS}^{cs , max} & if {N}_{ap}^{SRS} = 4 and {n}_{SRS}^{cs , max} = 6 \\ ( {n}_{CRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix} \qquad Equation ( 4 )$$

where Nₐₚ^{SRS}=4, pᵢ ∈ {1001, 1003}, n_{SRS}^{cs,max}=6,
offset=((pᵢ-1000)mod2)*cs_offset, cs_offset ∈ {1, 2};
n_{SRS}^{cc}∈ {0,1, . . . , n_{SRS}^{cs,max}-1} is contained in the higher layer parameter transmissionComb.

In one specific example embodiment, parameter of comb offset may be calculated based on below Equation (5).

$${k}_{TC}^{( {p}_{i} )} = \{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs} ∈ ( {n}_{SRS}^{cs , max} / 2 , … , {n}_{SRS}^{cs , max} - 1 \} \\ {\overline{k}}_{TC} & otherwise\end{matrix} \qquad Equation ( 5 )$$

where the transmission comb offset k̅_{TC}∈{0,1, . . . , K_{TC}-1} is contained in the higher-layer parameter transmissionComb in the SRS-Resource IE or the SRS-PosResource IE.

In the above specific example embodiments, for a 4-port SRS transmission with K_{TC}=8 (or n_{SRS}^{cs,max}=6), an additional offset (e.g. cs_offset, where the cs_offset may be 1 or 2) is introduced. In this way, ports #0, #2 and ports #1, #3 may be associated with different CSs.

It should be understood that, the above specific embodiment (where parameter offset is introduced) is illustrated only for the purpose of illustration without suggesting any limitations. In some other example embodiments, any suitable parameter may be introduced. The present disclosure is not limited in this regard.

### Example Processes for 8-Port SRS Transmission

As discussed above, in the following 3GPP release 18, the number of antenna ports for SRS transmission is expected to be increased up to 8. According to some example embodiments of the present disclosure, how to map the eight antenna ports according to different comb-structures will be discussed in detail.

In some embodiments, the terminal device 120 (and the network device 110) maps eight antenna ports of a SRS resource to a comb-structure resource according to a comb value of the comb-structure resource.

Generally speaking, if the CS values on each comb offset are different, the PAPR performance is best, and if CS values on at least two comb offset values are different, the PAPR performance is better than that all values of CS on any comb offset are the same. In view of this, according to some example embodiments of the present disclosure, at least two sets of REs based on at least two comb offset values are associated with different CSs (or different CS sets). In other words, at least two portions of the eight antenna ports are associated with different CSs (or different CS sets). After that, the terminal device 120 transmits a SRS transmission with the comb-structure resource. In this way, different REs (i.e., different portions of the eight antenna ports, or different comb offsets) may be associated with different CS(s), and the PAPR performance is ensured thereby.

In some embodiments, the at least two REs are two neighboring/closest REs. In this way, even there are not sufficient CSs to ensure each RE is associated with CS(s) different from all the other REs, the PAPR performance still may be optimized.

In some embodiments, a comb value of the comb-structure resource is one of the following {2, 4, 8, 12}. Additionally, associations between a comb value and a maximum number of CS values are pre-defined. Specifically, a maximum number of CS values is 8 if the comb value of comb-structure resource is 2, a maximum number of CS values is 12 if the comb value of comb-structure resource is 4 and a maximum number of CS values is 6 if the comb value of comb-structure resource is 8.

In one specific example embodiment, the maximum number of CS values (n_{SRS}^{cs,max}) is a function of the comb value (K_{TC}), as illustrated in below Table 1.

TABLE 1
maximum number of cyclic shifts
n_{SRS}^{cs,max} as a function of K_{TC}

| K_{TC} | n_{SRS}^{cs,max} |
|---|---|
| 2 | 8 |
| 4 | 12 |
| 8 | 6 |

In the following, some specific examples for different comb values will be discussed one by one.

### Comb Value Being 2

In some embodiments, if the comb value of the comb-structure resource is 2 (i.e., K_{TC}=2), the terminal device 120 (and the network device 110) maps a first portion of the eight antenna ports to a first set of REs based on a first comb offset, the first portion of the eight antenna ports being associated with a first CS set. Further, the terminal device 120 (and the network device 110) maps a second portion of the eight antenna ports to a second set of REs based on a second comb offset, the second portion of the eight antenna ports being associated with a second CS set. In particular, the second CS set is different from the first CS set.

In one specific example embodiment, the first CS set may be {n_CS, (n_CS+2) mod 8, (n_CS+4) mod 8, (n_CS+6) mod 8} while the second CS set may be {(n_CS+cs_offset) mod 8, (n_CS+2+cs_offset) mod 8, (n_CS+4+cs_offset) mod 8, (n_CS+6+cs_offset) mod 8}. Further, cs_offset may be 0 or 1. Additionally, the first comb offset may be different from the second comb offset. In one example, the first comb offset and the second comb offset may be 0 and 1 respectively. In another example, the first comb offset and the second comb offset may be 1 and 0 respectively.

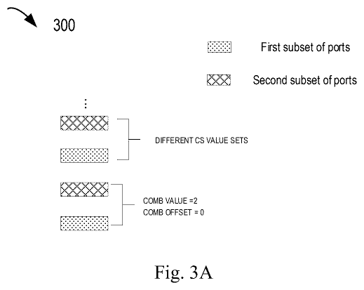

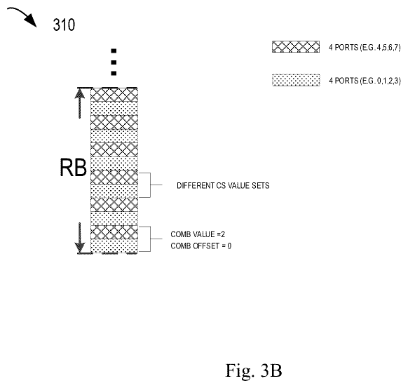

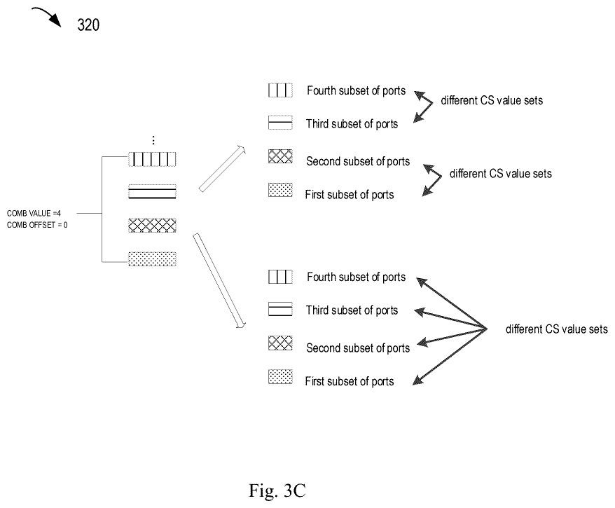

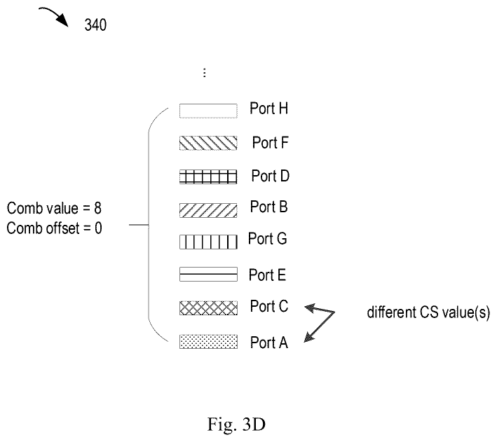

Reference is now made to FIG. 3A, which illustrates an example of antenna port mapping 300 for comb value of 2 according to some embodiments of the present disclosure.

In one specific example embodiment, CS value (n_{SRS}^{cs,j}) and the comb offset (k_{TC}^{(p}^{ᵢ}⁾) are calculated based on below Equation (6) and Equation (7).

$${n}_{SRS}^{cs , i} = ( {n}_{SRS}^{c s} + \frac{{n}_{SRS}^{cs , max} ( {p}_{i} - 1000 )}{{N}_{ap}^{SRS}} ) mod {n}_{SRS}^{cs , max} \qquad Equation ( 6 )$$

where Nₐₚ^{SRS}=8, n_{SRS}^{cs,max}=8, pᵢ∈{1001, 1003, 1005, 1007},
n_{SRS}^{cs}∈{0,1, . . . , n_{SRS}^{cs,max}-1} is contained in the higher layer parameter transmissionComb.

$${k}_{TC}^{( {p}_{i} )} = \{ \begin{matrix}( {\overline{k}}_{TC} + {K}_{TC} / 2 ) mod {K}_{TC} & if {N}_{ap}^{SRS} = 8 , {p}_{i} ∈ \{ 1001 , 1003 , 1005 , 1007 \} \\ {\overline{k}}_{TC} & otherwise\end{matrix} \qquad Equation ( 7 )$$

where the transmission comb offset k̅_{TC}∈{0,1, . . . , K_{TC}-1} is contained in the higher-layer parameter transmissionComb in the SRS-Resource IE or the SRS-PosResource IE.

Alternatively, in some other embodiments, if the comb value of the comb-structure resource is 2 (i.e., K_{TC}=2), the terminal device 120 (and the network device 110) maps a first portion of the eight antenna ports to a first set of REs based on a first comb offset, the first portion of the eight antenna ports being associated with a first CS set. Further, the terminal device 120 (and the network device 110) maps a second portion of the eight antenna ports to a second set of REs based on a second comb offset, the second portion of the eight antenna ports being associated with a second CS set. In particular, the second CS set is the same with the first CS set.

In one specific example embodiment, the first CS set and the second CS set may be {n_CS, (n_CS+2) mod 8, (n_CS+4) mod 8, (n_CS+6) mod 8}. Additionally, the first comb offset may be different from the second comb offset. In one example, the first comb offset and the second comb offset may be 0 and 1 respectively. In another example, the first comb offset and the second comb offset may be 1 and 0 respectively.

In one specific example embodiment, CS value (n_{SRS}^{cs,i}) and the comb offset (k_{TC}^{(p}^{ᵢ}⁾) are calculated based on below Equation (8) and Equation (9).

$${n}_{SRS}^{cs , i} = ( {n}_{SRS}^{c s} + \frac{{n}_{SRS}^{cs , max} ⌊ ( {p}_{i} - 1000 ) / 2 ⌋}{{N}_{ap}^{SRS}} ) mod {n}_{SRS}^{cs , max} \qquad Equation ( 8 )$$

where Nₐₚ^{SRS}=8, n_{SRS}^{cs,max}=8, pᵢ ∈ {1001, 1003, 1005, 1007},
n_{SRS}^{cs} ∈ {0,1, . . . , n_{SRS}^{cs,max}-1} is contained in the higher layer parameter transmissionComb.

$${k}_{TC}^{( {p}_{i} )} = \{ \begin{matrix}( {\overline{k}}_{TC} + {K}_{TC} / 2 ) mod {K}_{TC} & if {N}_{ap}^{SRS} = 8 , {p}_{i} ∈ \{ 1001 , 1003 , 1005 , 1007 \} \\ {\overline{k}}_{TC} & otherwise\end{matrix} \qquad Equation ( 9 )$$

where the transmission comb offset k̅_{TC}∈{0,1, . . . , K_{TC}-1} is contained in the higher-layer parameter transmissionComb in the SRS-Resource IE or the SRS-PosResource IE.

Alternatively, in some other embodiments, if the comb value of the comb-structure resource is 2 (i.e., K_{TC}=2), the terminal device 120 (and the network device 110) maps the eight antenna ports to a same set of REs based on a comb offset. In some other embodiments, the comb offset may be 0 or 1. Further, each antenna port of the eight antenna ports being associated with a respective CS. In one specific example embodiment, the CS for the eight antenna ports may be n_CS, (n_CS+1) mod 8, (n_CS+2) mod 8, (n_CS+3) mod 8, (n_CS+4) mod 8, (n_CS+5) mod 8, (n_CS+6) mod 8, (n_CS+7) mod 8, respectively.

In one specific example embodiment, CS value (n_{SRS}^{cs,i}) and the comb offset (k_{TC}^{(p}^{ᵢ}⁾ are calculated based on below Equation (10) and Equation (11).

$${n}_{SRS}^{cs , i} = ( {n}_{SRS}^{c s} + \frac{{n}_{SRS}^{cs , max} ( {p}_{i} - 1000 )}{{N}_{ap}^{SRS}} ) mod {n}_{SRS}^{cs , max} \qquad Equation ( 10 )$$

where Nₐₚ^{SRS}=8, n_{SRS}^{cs,max}=8, pᵢ∈{1000, 1001, 1002, 1003, 1004, 1005, 1006, 1007},
n_{SRS}^{cs}∈{0,1, . . . , n_{SRS}^{cs,max}-1} is contained in the higher layer parameter transmissionComb.

$${k}_{TC}^{( {p}_{i} )} = {\overline{k}}_{TC} \qquad Equation ( 11 )$$

In some embodiments, the transmission comb offset k̅_{TC}∈{0,1, . . . , K_{TC}-1} is contained in the higher-layer parameter transmissionComb in the SRS-Resource IE or the SRS-PosResource IE. Alternatively, the transmission comb offset k̅_{T}c E {0,1, . . . , K_{TC}-1} is a pre-defined default, such as 0 or 1.

Alternatively, in some embodiments, the mapping of the eight antenna ports may be implemented by the two sets of four antenna ports. In other words, the mapping of 8-port SRS is composed by two mappings of 4-port SRS. In this event, an additional comb offset (which may be “1”) and/or an additional CS offset (which may be “1”) may be introduced for the second set of 4 ports of the either antenna ports.

In one specific example embodiment, a CS value set for the first 4-port SRS on a first comb offset may be {a, b, c, d}, and another CS value set for the second 4-port SRS on a second comb offset may be {(a+additional CS offset) mod n_{SRS}^{cs,max}, (b+additional CS offset) mod n_{SRS}^{cs,max}, (c+additional CS offset) mod n_{SRS}^{cs,max}, (d+additional CS offset) mod n_{SRS}^{cs,max}}. Reference is now made to FIG. 3B, which illustrates an example of antenna port mapping 310 for comb value of 2 according to some embodiments of the present disclosure. In the specific example of FIG. 3B, the CS value set for the first port set (such as, {0, 2, 4, 6}) on the first comb offset may be {0, 2,4,6}, and the CS value set for the second port set (such as, {1, 3, 5, 7}) on the second comb offset may be {1,3,5,7}.

In the above specific example embodiments, some rules and parameters are defined or introduced for mapping the antenna ports. It is to be clarified that such rules and parameters may be defined by default. Specifically, such rules and parameters be stipulated by a wireless organization (such as, 3GPP), or a network operator, a service provider and so on. Alternatively, such rules and parameters may be configured by the network device 110 via such as, RRC message, DCI message, MAC CE message or any suitable message.

### Comb Value Being 4

In some embodiments, if the comb value of the comb-structure resource is 4 (i.e., K_{TC}=4), the terminal device 120 (and the network device 110) maps four antenna port sets of the eight antenna ports to four different set of REs based on four comb offset values. In particular, each antenna port set of the four antenna port sets comprises two antenna ports and different antenna port sets of the four antenna port sets or different set of REs may be associated with different CS sets.

Reference is now made to FIG. 3C, which illustrates an example of antenna port mapping 320 for comb value of 4 according to some embodiments of the present disclosure.

In one specific example embodiment, the first 2-port set may be mapped to REs based on a first value of comb offset, the second 2-port set may be mapped to REs based on a second value of comb offset, the third 2-port set may be mapped to REs based on a third value of comb offset, the fourth 2-port set may be mapped to REs based on a fourth value of comb offset CS. For example, the sets of CS values for the first to the fourth 2-port sets may be as below:
For the first 2-port set: {n_cs, n_cs+6} mod n_{SRS}^{cs,max};
For the second 2-port set: {n_cs+cs_offset 1, n_cs+cs_offset 1+6} mod n_{SRS}^{cs,max};
For the third 2-port set: {n_cs+cs_offset 2, n_cs+cs_offset 2+6} mod n_{SRS}^{cs,max}; and
For the fourth 2-port set: {n_cs+cs_offset 3, n_cs+cs_offset 3+6} mod n_{SRS}^{cs,max}.

In some embodiments, the first value of comb offset, the second value of comb offset, the third value of comb offset and the fourth value of comb offset may be at least one of {0, 1, 2, 3}. In addition, in some embodiments, the first value of comb offset, the second value of comb offset, the third value of comb offset and the fourth value of comb offset may be different from each other. In some embodiments, the first value of comb offset may be represented as k1. For example, k1 may be at least one of {0, 1, 2, 3}. In some embodiments, the second value of comb offset may be (k1+1) mod K_{TC}. Alternatively, in some other embodiments, the second value of comb offset may be (k1+2) mod K_{TC}. In some embodiments, the third value of comb offset may be (k1+2) mod K_{TC}. Alternatively, in some other embodiments, the third value of comb offset may be (k1+1) mod K_{TC}. In some embodiments, the fourth value of comb offset may be (k1+3) mod K_{TC}.

In some embodiments, the parameter “cs_offset 1/cs_offset 2/cs_offset 3” may be one of {0, 1, 2, 3, 4, 5}. In some embodiment, cs_offset 1, cs_offset 2 and cs_offset 3 may be different with each other. Alternatively, cs_offset 1 may be same with cs_offset 3, while cs_offset 2 may be 0. For example, cs_offset 1 and/or cs_offset 3 may be 3, and cs_offset 2 may be 0. Further, the value of cs_offset1 and/or cs_offset 2 and/or cs_offset 3 may be predetermined or configured via DCI and/or MAC CE and/or RRC.

Alternatively, in some embodiments, if the comb value of the comb-structure resource is 4 (i.e., K_{TC}=4), the terminal device 120 (and the network device 110) maps two antenna port sets of the eight antenna ports to two different set of REs based on a first comb offset and a second comb offset. In particular, each antenna port set of the two antenna port sets comprises four antenna ports and different antenna port sets of the two antenna port sets or different set of REs may be associated with different CS sets.

In one specific example embodiment, the first 4-ports set may be mapped to REs based on a first value of comb offset, and the second 4-ports set may be mapped to REs based on a second value of comb offset. Further, a first set of CS values for the first 4-ports set may be “{n_cs, n_cs+3, n_cs+6, n_cs+9} mod n_{SRS}^{cs,max}”, and a second set of CS values for the second 4-ports set may be “{n_cs+cs_offset, n_cs+cs_offset+3, n_cs+cs_offset+6, n_cs+cs_offset+9} mod n_{SRS}^{cs,max}”. In some embodiments, the parameter “cs_offset” may be one of {1, 2}. Further, the value of cs_offset may be predetermined or configured via DCI and/or MAC CE and/or RRC.

In the above specific example embodiments, some rules and parameters (cs_offset, cs_offset 1, cs_offset 2, cs_offset 3) are defined or introduced for mapping the antenna ports. It is to be clarified that such rules and parameters may be defined by default. Specifically, such rules and parameters may be stipulated by a wireless organization (such as, 3GPP), or a network operator, a service provider and so on. Alternatively, such rules and parameters may be configured by the network device 110 via such as, RRC message, DCI message, MAC CE message or any suitable message.

### Comb Value Being 8

In some embodiments, if the comb value of the comb-structure resource is 8 (i.e., K_{TC}=8), the terminal device 120 (and the network device 110) may map the eight antenna ports to REs based on eight comb offset values. Reference is now made to FIG. 3D, which illustrates an example of antenna port mapping 340 for comb value of 8 according to some embodiments of the present disclosure.

In one specific example embodiment, the eight antenna ports may be mapped on eight set of REs based on different values of comb offset, and sequences on two adjacent REs correspond to different values of CS. For example, CS values for the eight antenna ports (i.e., comb offset={0,1,2,3,4,5,6,7}) may be {n_cs, n_cs+1, n_cs+2, n_cs+3, n_cs+4, n_cs+5 n_cs n_cs+1} mod n_{SRS}^{cs,max} (such as, {0,1,2,3,4,5,0,1}), respectively.

Some other example sets of CS values are listed as below.
Set #1:1{0, 1, 0, 1, 0, 1, 0, 1}
Set #2: {0, 3, 1, 4, 2, 5, 0, 3};
Set #3: {0, 1, 2, 3, 4, 5, 0, 1}
Set #4: {0, 1, 2, 3, 0, 1, 2, 3}
Set #5: {0, 3, 1, 4, 2, 5, 1, 4};
Set #6: {0, 1, 0, 1, 2, 3, 2, 3};
Set #7: {0, 3, 1, 2, 0, 3, 1, 2}; and
Set #8: {0, 3, 0, 3, 0, 3, 0, 3}.

In some embodiments, scenario where a same CS value is associated with all the comb offsets (i.e, all the antenna ports) should be avoided. It is to be understood that the above example sets of CS values are illustrated only for the purpose of illustration without suggesting any limitations. In other example embodiments, other sets of CS values may be defined. The present disclosure is not limited in this regard.

In some embodiments, if the comb value of the comb-structure resource is 8 (i.e., K_{TC}=8), the terminal device 120 (and the network device 110) may map two antenna port sets of the eight antenna ports to two different sets of REs based on a first comb offset and a second comb offset. In particular, each antenna port set of the two antenna port sets comprises four antenna ports and different antenna port sets of the two antenna port sets or different sets of REs may be associated with different CS sets.

In some embodiments, the first value of comb offset and the second value of comb offset may be one of {0, 1, 2, 3, 4, 5, 6, 7}. In some embodiments, the first value of comb offset may be different from the second value of comb offset. In one specific example embodiment, the first value of comb offset may be represented as k1, where k1 may be one of {0, 1, 2, 3, 4, 5, 6, 7}, and the second value of comb offset may be (k1+4) mod K_{TC}.

In one specific example embodiment, the first 4-ports set may be mapped to REs based on a first value of comb offset, and the second 4-ports set may be mapped to REs based on a second value of comb offset. Further, a first set of CS values for the first 4-ports set may be “{n_cs, n_cs+1, n_cs+3, n_cs+4} mod n_{SRS}^{cs,max}” or “{n_cs, n_cs+2, n_cs+3, n_cs+5} mod n_{SRS}^{cs,max}”. Accordingly, a second set of CS values for the second 4-ports set may be “be {n_cs+cs_offset, n_cs+cs_offset+1, n_cs+cs_offset+3, n_cs+cs_offset+4} mod n_{SRS}^{cs,max}” or “{n_cs, n_cs+cs_offset+1 n_cs+3 n_cs+cs_offset+4} mod n_{SRS}^{cs,max}” or “{n_cs+cs_offset, n_cs+cs_offset+2, n_cs+cs_offset+3, n_cs+cs_offset+5} mod n_{SRS}^{cs,max}” or “{n_cs, n_cs+cs_offset+2, n_cs+3, n_cs+cs_offset+5} mod n_{SRS}^{cs,max}”. In some embodiments, the parameter “cs_offset” may be at least one of {1, 2}. Further, the value of cs_offset may be predetermined or configured via DCI and/or MAC CE and/or RRC.

In some embodiments, if the comb value of the comb-structure resource is 8 (i.e., K_{TC}=8), the terminal device 120 (and the network device 110) maps four antenna port sets of the eight antenna ports to four different set of REs based on four comb offset values (for example, the first value of comb offset, the second value of comb offset, the third value of comb offset and the fourth value of comb offset). In particular, each antenna port set of the four antenna port sets comprises two antenna ports and different antenna port sets of the four antenna port sets or different sets of REs may be associated with different CS sets.

In some embodiments, any of the first value of comb offset, the second value of comb offset, the third value of comb offset and the fourth value of comb offset may be one of {0, 1, 2, 3, 4, 5, 6, 7}. In one specific example embodiment, the first value of comb offset, the second value of comb offset, the third value of comb offset and the fourth value of comb offset may be different from each other. In another specific example embodiment, the first value of comb offset may be represented as k1, where k1 may be one of {0, 1, 2, 3, 4, 5, 6, 7}. In one specific example embodiment, the second value of comb offset may be (k1+2) mod K_{TC}. In another specific example embodiment, the second value of comb offset may be (k1+4) mod K_{TC}. In one specific example embodiment, the third value of comb offset may be (k1+4) mod K_{TC}. In another specific example embodiment, the third value of comb offset may be (k1+2) mod K_{TC}. In one specific example embodiment, the fourth value of comb offset may be (k1+6) mod K_{TC}.

In one specific example embodiment, the second value of comb offset may be (k1+1) mod K_{TC}. In another specific example embodiment, the second value of comb offset may be (k1+2) mod K_{TC}. In one specific example embodiment, the third value of comb offset may be (k1+2) mod K_{TC}. In another specific example embodiment, the third value of comb offset may be (k1+1) mod K_{TC}. In one specific example embodiment, the fourth value of comb offset may be (k1+3) mod K_{TC}.

In one specific example embodiment, the first 2-port set may be mapped to REs based on a first value of comb offset, the second 2-port set may be mapped to REs based on a second value of comb offset, the third 2-port set may be mapped to REs based on a third value of comb offset, the fourth 2-port set may be mapped to REs based on a fourth value of comb offset CS. The sets of CS values for the first to the fourth 2-port sets may be as below:
For the first 2-port set: {n_cs, n_cs+3} mod n_{SRS}^{cs,max};
For the second 2-port set: {n_cs+cs_offset 1, n_cs+cs_offset 1+3} mod n_{SRS}^{cs,max};
For the third 2-port set: {n_cs+cs_offset 2, n_cs+cs_offset 2+3} mod n_{SRS}^{cs,max}; and
For the fourth 2-port set: {n_cs+cs_offset 3, n_cs+cs_offset 3+3} mod n_{SRS}^{cs,max}.

In some embodiments, the parameter “cs_offset 1/cs_offset 2/cs_offset 3” may be one of {1, 2}. In some embodiment, cs_offset 1, cs_offset 2 and cs_offset 3 may be different with each other. Alternatively, cs_offset 1 may be the same with cs_offset 3. Alternatively, cs_offset 2 may be 0. In one specific example embodiment, cs_offset 1 and/or cs_offset 3 may be 3 and/or cs_offset 2 may be 0. In another specific example embodiment, the value of cs_offset1 and/or cs_offset 2 and/or cs_offset 3 may be predetermined or configured via DCI and/or MAC CE and/or RRC.

In the above specific example embodiments, some rules and parameters (cs_offset, cs_offset 1, cs_offset 2, cs_offset 3) may be defined or introduced for mapping the antenna ports. It is to be clarified that such rules and parameters may be defined by default. Specifically, such rules and parameters be stipulated by a wireless organization (such as, 3GPP), or a network operator, a service provider and so on. Alternatively, such rules and parameters may be configured by the network device 110 via such as, RRC message, DCI message, MAC CE message or any suitable message.

### By Using TD-OCC

In addition to the above, the mapping of eight antenna ports for a SRS transmission also may be implemented by using TD-OCC, which will be discussed in detail.

In some embodiments, the terminal device 120 (and the network device 110) maps the eight antenna ports of a SRS resource to a plurality of OFDM symbols by using at least one TD-OCC.

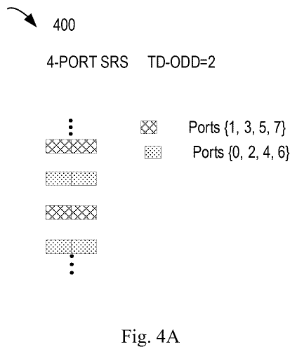

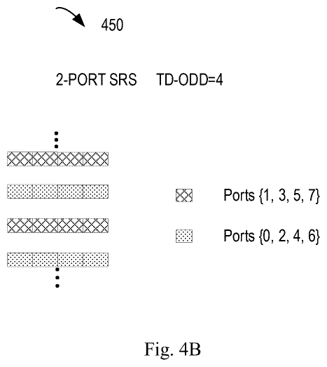

In some embodiments, the terminal device 120 (and the network device 110) may map the eight antenna ports on two symbols based on TD-OCC=2. In some embodiments, the terminal device 120 (and the network device 110) may map the eight antenna ports by using a 4-port SRS structure on two symbols combined with TD-OCC=2. Specifically, the terminal device 120 (and the network device 110) may map a first four antenna ports based on a first time TD-OCC, and maps a second four antenna ports based on a second TD-OCC, where a length of the first and the second TD-OCCs is 2. In one specific example embodiment, the first TD-OCC on the two symbols may be {1, 1}, while the second TD-OCC on the two symbols may be {1, −1}. FIG. 4A illustrates an example of antenna port mapping 400 for a length of TD-OCC being 2 according to some embodiments of the present disclosure.

Below Table 2 illustrates an example correspondence between the antenna port sets and the different values of TD-OCC.

TABLE 2
an example of correspondence

| antenna port sets | TD-OCC (length-2) | |
|---|---|---|
| 0, 1, 2, 3 or 0, 2, 4, 6 | 1 | 1 |
| 4, 5, 6, 7 or 1, 3, 5, 7 | 1 | −1 |

In some embodiments, the terminal device 120 (and the network device 110) may map the eight antenna ports on four symbols based on TD-OCC=4. Alternatively, in some other embodiments, the terminal device 120 (and the network device 110) may map the eight antenna ports by using a 2-port SRS structure on four symbols combined with TD-OCC=4. Specifically, the terminal device 120 (and the network device 110) may map four antenna port sets of the eight antenna ports based on four different TD-OCCs with a length of 4, where each of the four antenna port sets may comprise two antenna ports. In one specific example embodiment the first TD-OCC on the four symbols may be {1, 1, 1, 1}, the second TD-OCC on the four symbols may be {1, −1, 1, −1}, the third TD-OCC on the four symbols may be {1, 1, −1, −1} or {1, −1, −1, 1} and the fourth TD-OCC on the four symbols may be {1, −1, −1, 1} or {1, 1, −1, −1}. FIG. 4B illustrates an example of antenna port mapping 450 for a length of TD-OCC being 4 according to some embodiments of the present disclosure.

Below Tables 3 and 4 illustrates two example correspondences between the antenna port sets and the different values of TD-OCC.

TABLE 3
an example of correspondence

| antenna port sets | TD-OCC (length-4) | | | |
|---|---|---|---|---|
| 0, 1 or 0, 2 | 1 | 1 | 1 | 1 |
| 2, 3 or 1, 3 | 1 | −1 | 1 | −1 |
| 4, 5 or 4, 6 | 1 | −1 | −1 | 1 |
| 6, 7 or 5, 7 | 1 | 1 | −1 | −1 |

TABLE 4
another example of correspondence

| antenna port sets | TD-OCC (length-4) | | | |
|---|---|---|---|---|
| 0, 1, 2, 3 or 0, 2, 4, 6 | 1 | 1 | 1*(−1).\hat{ }X | 1*(−1).\hat{ }X |
| 4, 5, 6, 7 or 1, 3, 5, 7 | 1 | −1 | 1*(−1).\hat{ }X | −1*(−1).\hat{ }X |

It is to be clarified that the specific mapping manners illustrated in FIGS. 4A and 4B, and the specific values of TD-OCC illustrated in Tables 2˜4 are illustrated only for the purpose of illustration without suggesting any limitations. In other example embodiments, other suitable mapping manners for 4-port SRS structure/2-port SRS structure and other suitable values of TD-OCC may be applied. The present disclosure is not limited in this regard.

### Example Processes for Enhancements on SRS Capacity/Randomization

Generally speaking, to obtain orthogonality (between partial overlapping SRS) based on TD-OCC, sequences on different symbols should be same while sequence or group hopping is applied for interference randomization. In the following 3GPP release 18, it is expected that further enhancement on SRS capacity/randomization will be discussed. Specifically, the below targets is expected to be defined:
Capacity: support technology of TD-OCC, while the sequence on different symbols should be designed to obtain orthogonality;
Randomization: try to introduce dynamic/flexible randomization parameter, e.g. for group and/or sequence hopping parameters.

According to some example embodiments of the present disclosure, sequences for SRS antenna ports may be same on OFDM symbols within the TD-OCC length, and sequences on OFDM symbols outside/beyond one TD-OCC length can be different if group or sequence hopping is used. In this way, a trade-off between the capacity requirement and the randomization requirement is achieved.

In some embodiments, the terminal device 120 (and the network device 110) determines at least one sequence of TD-OCC for a plurality of symbols (i.e, orthogonal frequency division multiplexing, OFDM, symbols). In particular, sequences of the SRS antenna ports being used within a symbol period is the same, where the symbol period corresponds to a number of OFDM symbols based on the length of the TD-OCC.

Then, the terminal device 120 transmits a SRS transmission over the plurality of symbols to the network device 110 based on the determined at least one sequence and the at least one sequence of TD-OCC.

In some embodiments, the at least one sequence of TD-OCC may be determined based on a plurality of factors. One example factor is the length of the TD-OCC. Another example factor is a UE specific parameter, or a cell specific parameter. A further example factor is an interference randomization parameter for a group hopping or a sequence hopping.

In some embodiments, the length of the TD-OCC (be represented as TD) is considered when determining the at least one sequence of TD-OCC for each symbol.

In one specific embodiment, if groupOrSequenceHopping equals ‘groupHopping’, group hopping but not sequence hopping shall be used and sequence of TD-OCC for each symbol should be determined based on below Equation (12).

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + ⌊ \frac{{l}^{′}}{TD} ⌋ ) + m ) \cdot {2}^{m} ) mod 30 \qquad Equation ( 12 )$$

$$v = 0$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{ID}^{SRS} at the beginning of each radio frame;
m is integer belong to {0, 7};
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame; and
TD ∈ {2,4} is the length of TD-OCC configured for SRS.

Alternatively, if groupOrSequenceHopping equals ‘sequenceHopping’, sequence hopping but not group hopping shall be used and sequence of TD-OCC for each symbol should be determined based on below Equation (13).

$${f}_{gh} ( {n}_{s , f}^{μ} , {l}^{′} ) = 0 \qquad Equation ( 13 )$$

$$v = \{ \begin{matrix}c ( {n}_{s , f}^{μ} {N}_{symb}^{slot} + {l}_{0} + ⌊ \frac{{l}^{′}}{TD} ⌋ ) & {M}_{sc , b}^{SRS} \geq 6 {N}_{sc}^{RB} \\ 0 & otherwise\end{matrix}$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{ID}^{SRS} at the beginning of each radio frame;
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame;
M_{sc,b}^{SRS} refers to the length of the sounding reference signal sequence;
N_{sc}^{RB}=12 refers to a number of sun-carriers within a resource block; and
TD ∈ {2,4} is the length of TD-OCC configured for SRS.

In the above specific examples, a new parameter

$$“ ⌊ \frac{{l}^{′}}{TD} ⌋ ”$$

is introduced for determining the sequence of TD-OCC. Below Table 5 illustrates values of the newly-introduced parameter

$$“ ⌊ \frac{{l}^{′}}{TD} ⌋ ”$$

according to different values of TD (the length of TD-OCC configured for SRS).

TABLE 5
$values of the newly ‐ introduced parameter “ ⌊ \frac{{l}^{′}}{TD} ⌋ ”$

| | OFDM = 0 | OFDM = 1 | OFDM = 2 | OFDM = 3 | OFDM = 4 | OFDM = 5 | OFDM = 6 | OFDM = 7 |
|---|---|---|---|---|---|---|---|---|
| $⌊ \frac{{l}^{′}}{TD} ⌋$ | 0 | 0 | 1 | 1 | 2 | 2 | 3 | 3 |
| (TD = 2) | | | | | | | | |
| $⌊ \frac{{l}^{′}}{TD} ⌋$ | 0 | 0 | 0 | 0 | 1 | 1 | 1 | 1 |
| (TD = 4) | | | | | | | | |

As can be seen from the above Table, the values of the newly-introduced parameter

$$“ ⌊ \frac{{l}^{′}}{TD} ⌋ ”$$

is the same within the length of TD-OCC. In this way, it is guaranteed that the sequences of TD-OCC are kept the same within the TD-OCC length, and sequences outside one TD-OCC length can be different if group or sequence hopping is used.

Other example embodiments for determining the sequences of TD-OCC are discussed as below.

In one specific embodiment, if groupOrSequenceHopping equals ‘groupHopping’, group hopping but not sequence hopping shall be used and sequence of TD-OCC for each symbol should be determined based on below Equation (14).

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + ⌊ \frac{{l}^{′}}{TD} ⌋ \cdot TD ) + m ) \cdot {2}^{m} ) mod 30 \qquad Equation ( 14 )$$

$$v = 0$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{ID}^{SRS} at the beginning of each radio frame;
m is integer belong to {0, 7};
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame; and
TD ∈ {2,4} is the length of TD-OCC configured for SRS.

Alternatively, if groupOrSequenceHopping equals ‘sequenceHopping’, sequence hopping but not group hopping shall be used and sequence of TD-OCC for each symbol should be determined based on below Equation (15)

$${f}_{gh} ( {n}_{s , f}^{μ} , {l}^{′} ) = 0 \\ v = \{ \begin{matrix}c ( {n}_{s , f}^{μ} {N}_{symb}^{slot} + {l}_{0} + ⌊ \frac{{l}^{′}}{TD} ⌋ \cdot TD ) & {{M}_{sc , b}^{SRS} \geq 6 {N}_{sc}^{RB}}_{otherwise} \\ 0 & \end{matrix} \qquad Equation ( 15 )$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{ID}^{SRS} at the beginning of each radio frame;
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame;
M_{sc,b}^{SRS} refers to the length of the sounding reference signal sequence;
N_{sc}^{RB}=12 refers to a number of sun-carriers within a resource block; and
TD ∈ {2,4} is the length of TD-OCC configured for SRS.

In the above specific examples, a new parameter

$$“ ⌊ \frac{{l}^{′}}{TD} ⌋ \cdot TD ”$$

is introduced for determining the sequence of TD-OCC. Below Table 6 illustrates values of the newly-introduced parameter

$$“ ⌊ \frac{{l}^{′}}{TD} ⌋ \cdot TD ”$$

according to different values of TD (the length of TD-OCC configured for SRS).

TABLE 6
$values of the newly ‐ introduced parameter “ ⌊ \frac{{l}^{′}}{TD} ⌋ \cdot TD ”$

| | OFDM = 0 | OFDM = 1 | OFDM = 2 | OFDM = 3 | OFDM = 4 | OFDM = 5 | OFDM = 6 | OFDM = 7 |
|---|---|---|---|---|---|---|---|---|
| $⌊ \frac{{l}^{′}}{TD} ⌋ \cdot TD$ | 0 | 0 | 2 | 2 | 4 | 4 | 6 | 6 |
| (TD = 2) | | | | | | | | |
| $⌊ \frac{{l}^{′}}{TD} ⌋ \cdot TD$ | 0 | 0 | 0 | 0 | 4 | 4 | 4 | 4 |
| (TD = 4) | | | | | | | | |

In a further specific embodiment, if groupOrSequenceHopping equals ‘groupHopping’, group hopping but not sequence hopping shall be used and sequence of TD-OCC for each symbol should be determined based on below Equation (16).

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + ⌊ \frac{{l}^{′}}{TD} ⌋ \cdot TD + X ) + m ) \cdot {2}^{m} ) mod 30 \\ v = 0 \qquad Equation ( 16 )$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{ID}^{SRS} at the beginning of each radio frame;
m is integer belong to {0, 7};
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame;
TD ∈ {2,4} is the length of TD-OCC configured for SRS; and
X refers to a UE specific or cell specific parameter. In one specific example embodiment, X may be one of {0,1, . . . TD-1} according to different UEs or cells. Alternatively, in one specific example embodiment, X=Y mod TD, where Y may be a UE specific or cell specific parameter. For example, Y may be one of UE identity (ID), radio network temporary identifier (RNTI) value, TRP index, symbol index, slot index, subframe index, SRS resource ID, SRS resource set ID, frame index and a value configured either by the terminal device 120 or the network device 110 via at least one of RRC, MAC CE and DCI.

Alternatively, if groupOrSequenceHopping equals ‘sequenceHopping’, sequence hopping but not group hopping shall be used and sequence of TD-OCC for each symbol should be determined based on below Equation (17)

$${f}_{gh} ( {n}_{s , f}^{μ} , {l}^{′} ) = 0 \\ v = \{ \begin{matrix}c ( {n}_{s , f}^{μ} {N}_{symb}^{slot} + {l}_{0} + ⌊ \frac{{l}^{′}}{TD} ⌋ \cdot TD + X ) & {{M}_{sc , b}^{SRS} \geq 6 {N}_{sc}^{RB}}_{otherwise} \\ 0 & \end{matrix} \qquad Equation ( 17 )$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{ID}^{SRS} at the beginning of each radio frame;
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame; and
M_{sc,b}^{SRS} refers to the length of the sounding reference signal sequence;
N_{sc}^{RB}=12 refers to a number of sun-carriers within a resource block;
TD ∈ {2,4} is the length of TD-OCC configured for SRS; and
X refers to a UE specific or cell specific parameter. In one specific example embodiment, X may be one of {0,1, . . . TD-1} according to different UEs or cells. Alternatively, in one specific example embodiment, X=Y mod TD, where Y may be a UE specific or cell specific parameter. For example, Y may be one of UE ID, RNTI value, symbol index, TRP index, slot index, subframe index, SRS resource ID, SRS resource set ID, frame index and a value configured either by the terminal device 120 or the network device 110 via at least one of RRC, MAC CE and DCI.

In the above specific examples, a new parameter

$$“ ⌊ \frac{{l}^{′}}{TD} ⌋ \cdot TD + X ”$$

is introduced for determining the sequence of TD-OCC. Below Table 3 illustrates values of the newly-introduced parameter

$$“ ⌊ \frac{{l}^{′}}{TD} ⌋ \cdot TD + X ”$$

according to different values of TD (the length of TD-OCC configured for SRS).

TABLE 7
$values of the newly ‐ introduced parameter “ ⌊ \frac{{l}^{′}}{TD} ⌋ \cdot TD + X ”$

| | OFDM = 0 | OFDM = 1 | OFDM = 2 | OFDM = 3 | OFDM = 4 | OFDM = 5 | OFDM = 6 | OFDM = 7 |
|---|---|---|---|---|---|---|---|---|
| $⌊ \frac{{l}^{′}}{TD} ⌋ \cdot TD + X$ | 0 | 0 | 2 | 2 | 4 | 4 | 6 | 6 |
| (TD = 2, X = 0) | | | | | | | | |
| $⌊ \frac{{l}^{′}}{TD} ⌋ \cdot TD + X$ | 1 | 1 | 3 | 3 | 5 | 5 | 7 | 7 |
| (TD = 2, X = 1) | | | | | | | | |
| $⌊ \frac{{l}^{′}}{TD} ⌋ \cdot TD + X$ | 0 | 0 | 0 | 0 | 4 | 4 | 4 | 4 |
| (TD = 4, X = 0) | | | | | | | | |
| $⌊ \frac{{l}^{′}}{TD} ⌋ \cdot TD + X$ | 1 | 1 | 1 | 1 | 5 | 5 | 5 | 5 |
| (TD = 4, X = 1) | | | | | | | | |
| $⌊ \frac{{l}^{′}}{TD} ⌋ \cdot TD + X$ | 2 | 2 | 2 | 2 | 6 | 6 | 6 | 6 |
| (TD = 4, X = 2) | | | | | | | | |
| $⌊ \frac{{l}^{′}}{TD} ⌋ \cdot TD + X$ | 3 | 3 | 3 | 3 | 7 | 7 | 7 | 7 |
| (TD = 4, X = 3) | | | | | | | | |

With the newly-introduced parameter

$$“ ⌊ \frac{{l}^{′}}{TD} ⌋ \cdot TD + X ” ,$$

the orthogonalization among different UEs or cells is ensured.

In addition, in the related solution, a pseudo-random sequence for SRS group and/or sequence hopping is actually based on cell-specific parameters (e.g. slot index, symbol index). According to some example embodiments of the present disclosure, the procedure of interference randomization also may be improved. Specifically, in order to enhance inter-TRP cross-SRS interference, an additional parameter (be represented as “R”) may be introduced for group and/or sequence hopping.

In one specific embodiment, if groupOrSequenceHopping equals ‘groupHopping’, group hopping but not sequence hopping shall be used and sequence of TD-OCC for each symbol should be determined based on below Equation (18).

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} + R ) + m ) \cdot {2}^{m} ) mod 30 \qquad Equation ( 18 )$$

$$v = 0$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{ID}^{SRS} at the beginning of each radio frame;
m is integer belong to {0, 7};
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame; and
R refers to an additional parameter. In one specific example embodiment, the parameter R may be an index, e.g. TRP index. For example, R may be one of UE ID, RNTI value, TRP index, symbol index, slot index, subframe index, SRS resource ID, SRS resource set ID, frame index and a value configured either by the terminal device 120 or the network device 110 via at least one of RRC, MAC CE and DCI.

Alternatively, if groupOrSequenceHopping equals ‘sequenceHopping’, sequence hopping but not group hopping shall be used and sequence of TD-OCC for each symbol should be determined based on below Equation (19).

$${f}_{gh} ( {n}_{s , f}^{μ} , {l}^{′} ) = 0 v = \{ \begin{matrix}c ( {n}_{s , f}^{μ} {N}_{symb}^{slot} + {l}_{0} + {l}^{′} + R ) & {{M}_{sc , b}^{SRS} \geq 6 {N}_{sc}^{RB}}_{otherwise} \\ 0 & \end{matrix} \qquad Equation ( 19 )$$

where, l₀ refers to the starting position in the time domain given by l₀=N_{symb}^{slot}-1-l_{offset};
the quantity l′ ∈ {0,1, . . . , N_{symb}^{SRS}-1} is the OFDM symbol number within the SRS resource;
l_{offset}: counts symbols backwards from the end of a slot, given by the field startPosition contained in the higher layer parameter resourceMapping; For example, the value of l_{offset} may be one of {0, 1, 2, 3, 4, 5, 6, 7, 8, 9, 10, 11, 12, 13};
c(i) refers to a pseudo-random sequence and shall be initialized with cᵢₙᵢₜ=n_{id}^{SRS} at the beginning of each radio frame;
N_{symb}^{slot} refers to a number of consecutive OFDM symbols in a slot;
n_{s,f}^{μ} ∈ {0, . . . , Nₛₗₒₜ^{frame,μ}-1} refers to an index of OFDM symbol in increasing order within a frame; and
M_{sc,b}^{SRS} refers to the length of the sounding reference signal sequence;
N_{sc}^{RB}=12 refers to a number of sun-carriers within a resource block; and
R refers to an additional parameter. In one specific example embodiment, the parameter R may be an index, e.g. TRP index. For example, R may be one of UE ID, RNTI value, TRP index, symbol index, slot index, subframe index, SRS resource ID, SRS resource set ID, frame index and a value configured either by the terminal device 120 or the network device 110 via at least one of RRC, MAC CE and DCI.

In the above specific example embodiments, a new parameter “R” is introduced for determining the sequence of TD-OCC. It is to be clarified that the parameter “R” may be defined by default. Specifically, the parameter “R” may be stipulated by a wireless organization (such as, 3GPP), or a network operator, a service provider and so on. Alternatively, the parameter “R” may be configured by the network device 110 via such as, RRC message, DCI message, MAC CE message or any suitable message.

### Example Processes for DMRS Type 1 Transmission

As discussed above, in the following release 18, more orthogonal DMRS ports will be introduced. Specifically, the number of antenna ports for DMRS type 1 transmission is expected to be increased up to 16. According to the example embodiments of the present disclosure, how to design the CS will be discussed in detail.

In one specific example embodiment, the CS value (ap) may be determined based on below Equation (20).

$${a}_{k , l}^{( p , μ )} = β {e}^{j 2 π {α}_{p} ( 2 n + {k}^{′} ) / {CS}_{max}} {w}_{t} ( {l}^{′} ) r ( 2 n + {k}^{′} ) k = 4 n + {k}^{′} + Δ {k}^{′} = 0 , 1 l = \overline{l} + {l}^{′} n = 0 , 1 , … \qquad Equation ( 20 )$$

In some embodiments, for DMRS of physical downlink shared channel (PDSCH), β may be a power factor. In some embodiments, for DMRS of physical uplink shared channel (PUSCH), β may be 1 or there is no need of β in the Equation (20).

In some embodiments, l may be a reference point for DMRS in time domain. For example, l may be defined relative to the start of a slot for PDSCH mapping type A. For another example, l may be defined relative to the start of the scheduled PDSCH resources for PDSCH mapping type B.

In some embodiments, I may be the position(s) of DMRS symbol in a slot. For example, l̅ may be an index of OFDM symbol. In some embodiments, l′ may be the time domain index for DMRS. For example, the value of l′ may be {0, 1}.

In some embodiments, Δ may be an offset value of RE for the DMRS. For example, the value of Δ may be {0, 1} for DMRS type 1. For another example, the value of Δ may be {0, 1, 2} for DMRS type 2.

In some embodiments, wₜ(l′) may be a TD-OCC value. For example, wₜ(l′) may be {1, 1} for l′=0,1, respectively. For another example, wₜ(l′) may be {1, −1} for l′=0, 1, respectively.

In some embodiments, r(2n+k′) may be a sequence defined based on

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

Parameter c(i) may be a pseudo-random sequence.

In some embodiments, the terminal device 120 (and the network device 110) determines at least one CS for a DMRS type 1 transmission with more than eight antenna ports (such as, 16 antenna ports). In particular, four CSs of the at least one CS being orthonormal to each other. In one specific example embodiment, the CSs may be orthogonal to each other with a minimum orthonormal length of 6.

In some embodiment, a set of CS values (i.e., ap) may be one of the following: {0, 1, 3, 4} or {0, 2, 3, 5}. For example, when a maximum number of values of the at least one CS is 6 or CSₘₐₓ=6, a set of CS may be e^{j2πα}^{ₚ}^{·m/CS}^{ₘₐₓ}, where, m may be the index of RE for DMRS, for example, m=2n+k′.

In one specific example embodiment, for antenna ports comprise two portions, i.e., the first portion (such as, ports 0, 1, . . . , 7 and the second portion (corresponding to the newly-introduced antenna ports, be represented as ports A, B . . . ). For example, the second portion may be ports 8, 9, 10, 11, 12, 13, 14, 15. In this event, A may be one of {8, 9, 10, 11, 12, 13, 14, 15}, while B may be at least one of {8, 9, 10, 11, 12, 13, 14, 15}, where A is different from B. In some embodiments, for the first portion (where legacy FD-OCC [1,1] and [1, −1] may be applied), the CS values may be αₚ={0, 3}, while for the second portion (i.e., the newly-introduced antenna ports), the CS values may be αₚ={1, 4} or {2, 5}.

In some embodiment, a set of CS values (i.e., αₚ) may be one of the following: {0, 2, 6, 8} or {0, 4, 6, 10}. For example, when a maximum number of values of the at least one CS is 12 or CSₘₐₓ=12, a set of cyclic shift may be e^{j2πα}^{ₚ}^{·m/CS}^{ₘₐₓ}, where m may be the index of RE for DMRS, for example, m=2n+k′.

In one specific example embodiment, for antenna ports comprise two portions, i.e., the first portion (such as, ports 0, 1, . . . , 7 and the second portion (corresponding to the newly-introduced antenna ports, be represented as ports A, B . . . ). For example, the second portion may be ports 8, 9, 10, 11, 12, 13, 14, 15. For example, A may be one of {8, 9, 10, 11, 12, 13, 14, 15}, while B may be at least one of {8, 9, 10, 11, 12, 13, 14, 15}, where A is different from B. In some embodiments, for the first portion (where legacy FD-OCC [1,1] and [1, −1] may be applied), the CS values αₚ={0, 6}, while for the second portion (i.e., the newly-introduced antenna ports), the CS values αₚ={2, 8}, {4, 10}.

Below Table 8 illustrates examples of different values for respective ports. It is to be clarified that ports {0, 1, 8, 9} are illustrated only for the purpose of illustration without suggesting any limitations. The other ports, such as {2, 3, 10, 11}, {4, 5, 12, 13} and {6, 7 14, 15}, may be determined similarly.

Table 8 illustrates examples of different values for respective ports

| Ports | CS: e^{j*α}ₚ^{*2πq/6}, q = 2n + k′ | | | | | |
|---|---|---|---|---|---|---|
| 0 | e^{j0*2π0/6} | e^{j0*2π1/6} | e^{j0*2π2/6} | e^{j0*2π3/6} | e^{j0*2π4/6} | e^{j0*2π5/6} |
| (α₀ = 0) | 1 | 1 | 1 | 1 | 1 | 1 |
| 1 | e^{j3*2π0/6} | e^{j3*2π1/6} | e^{j3*2π2/6} | e^{j3*2π3/6} | e^{j3*2π4/6} | e^{j3*2π5/6} |
| (α₁ = 3) | 1 | −1 | 1 | −1 | 1 | −1 |
| 8 | e^{j1*2π0/6} | e^{j1*2π1/6} | e^{j1*2π2/6} | e^{j1*2π3/6} | e^{j1*2π4/6} | e^{j1*2π5/6} |
| (α₈ = 1) | | | | | | |
| 9 | e^{j4*2π0/6} | e^{j4*2π1/6} | e^{j4*2π2/6} | e^{j4*2π3/6} | e^{j4*2π4/6} | e^{j4*2π5/6} |
| (α₉ = 4) | | | | | | |

In this way, orthogonality can be achieved within a RB.

Alternatively, in some embodiments, the terminal device 120 (and the network device 110) determines at least one CS for a DMRS type 1 transmission with more than eight antenna ports (such as, 16 antenna ports). In particular, four CSs of the at least one CS being orthonormal to each other. In one specific example embodiment, the CSs may be orthogonal to each other with a minimum orthonormal length of 4.

In some embodiment, a set of CS values (i.e., αₚ) may be {0, 3, 6, 9}. For example, when a maximum number of values of the at least one CS is 12 or CSₘₐₓ=12, a set of CS may be e^{j2πα}^{ₚ}^{·m/CS}^{ₘₐₓ}, where m may be the index of RE for DMRS. For example, m=2n+k′.

In one specific example embodiment, for antenna ports comprise two portions, i.e., the first portion (such as, ports 0, 1, . . . , 7 and the second portion (corresponding to the newly-introduced antenna ports, be represented as ports A, B . . . ). For example, the second portion may be ports 8, 9, 10, 11, 12, 13, 14, 15. For example, A may be one of {8, 9, 10, 11, 12, 13, 14, 15} while B also may be one of {8, 9, 10, 11, 12, 13, 14, 15}. Further, A is different from B. In some embodiments, for the first portion (where legacy FD-OCC [1,1] and [1, −1] may be applied), the CS values αₚ={0, 6}, while for the second portion (i.e., the newly-introduced antenna ports), the CS values αₚ={3, 9}.

In some embodiments, for the first portion (such as, ports {0, 1}, ports {2, 3}, ports {4, 5}, ports {6, 7}), the FD-OCCs may be [1, 1, 1, 1] and [1, −1, 1, −1], while for the second portion (i.e., the newly-introduced antenna ports, such as, ports {8, 9}, ports {10, 11}, ports {12, 13}, ports {14, 15}), the FD-OCCs may be [1, 1, −1, −1] and [1, −1, −1, 1].

Below Table 9 illustrates examples of different values for respective ports. It is to be clarified that ports {0, 1, 8, 9} are illustrated only for the purpose of illustration without suggesting any limitations. The other ports, such as {2, 3, 10, 11}, {4, 5, 12, 13} and {6, 7 14, 15}, may be determined similarly.

Table 9 illustrates examples of different values for respective ports

TABLE 9
illustrates examples of different values for respective ports

| Ports | CS: e^{j*α*2πq/12}, q = 2n + k′ | | | |
|---|---|---|---|---|
| 0 | e^{j0*2π0/12} | e^{j0*2π1/12} | e^{j0*2π2/12} | e^{j0*2π3/12} |
| (α₀ = 0) | 1 | 1 | 1 | 1 |
| 1 | e^{j6*2π0/12} | e^{j6*2π1/12} | e^{j6*2π2/12} | e^{j6*2π3/12} |
| (α₁= 6) | 1 | −1 | 1 | −1 |
| 8 | e^{j3*2π0/12} | e^{j3*2π1/12} | e^{j3*2π2/12} | e^{j3*2π3/12} |
| (α₈ = 3) | | | | |
| 9 | e^{j9*2π0/12} | e^{j9*2π1/12} | e^{j9*2π2/12} | e^{j9*2π3/12} |
| (α₉ = 9) | | | | |

In this way, orthogonality can be achieved within four successive REs.

In some embodiments, the orthonormal length may be dynamically determined based on a number of scheduled RBs. Specifically, in some embodiment, if a number of scheduled RBs is an odd number, the orthonormal length is 6, while if a number of scheduled RBs is an even number, the orthonormal length is 4.

In some embodiment, the network device 110 may generates a configuration, where the configuration indicating information about at least one antenna port for the DMRS transmission, and information about at least one CS value corresponding to the at least one antenna port. Further, the configuration may be comprised in an RRC message, DCI message, MAC CE message or any suitable message.

In one specific example embodiment, if a maximum number of values of the at least one CS is 12, the network device 110 may indicate or configure the CS values (such as, values of {α_{A}, α_{B}}) for the newly-introduced ports (such as, ports {A, B}), where the CS values of {α_{A}, α_{B}} may be one of {3, 9} or {2, 8} or {4, 10}.

In another specific example embodiment, if a maximum number of values of the at least one CS is 12, the CS values for the newly-introduced ports (such as, ports {A, B}) may be determined based on one or more factors. One example factor is slot index. Another example factor is symbol index. A further example factor is a UE specific identifier. Further, the CS values of {α_{A}, α_{B}} may be one of {3, 9} or {2, 8} or {4, 10}. Additionally, CS values of {α_{A}, α_{B}} may be determined by below Equations (21) or (22).

$${α}_{A} = 2 + 2 * ( X mod 2 ) , {α}_{B} = 8 + 2 * ( X mod 2 ) \qquad Equation ( 21 )$$

$${α}_{A} = 2 + X mod 3 , {α}_{B} = 8 + X mod 3 \qquad Equation ( 22 )$$

where X refers to a factor for determining the CS values, and X may be one of a slot index, a symbol index, a UE specific identifier, RNTI value, TRP index, subframe index, scrambling ID, frame index and a value configured either by the terminal device 120 or the network device 110 via at least one of RRC, MAC CE and DCI.

In this way, more flexibility on scheduling DMRS transmission can be achieved based on different configurations/scheduling.

According to some example embodiments of the present disclosure, the shorter orthonormal length may be achieved by sacrificing some transmission resources.

Below Tables 10 and 11 illustrate examples of different FD-OCCs for respective ports. It is to be clarified that ports {0, 1, 8, 9} are illustrated only for the purpose of illustration without suggesting any limitations. The other ports, such as {2, 3, 10, 11}, {4, 5, 12, 13} and {6, 7 14, 15}, may be determined similarly.

Table 10 illustrates examples of FD-OCCs for respective ports

| | |
|---|---|
| Ports | FD-OCC |

| | | | | | | |
|---|---|---|---|---|---|---|
| 0 | 1 | 1 | 1 | 1 | 1 | 1 |
| 1 | 1 | −1 | 1 | −1 | 1 | −1 |
| 8 | 1 | −1 | 0 | 0 | −1 | 1 |
| 9 | 1 | 1 | 0 | 0 | −1 | −1 |

Table 11 illustrates further examples of FD-OCCs for respective ports

| | |
|---|---|
| Ports | FD-OCC |

| | | | | | | |
|---|---|---|---|---|---|---|
| 0 | 1 | 1 | 1 | 1 | 1 | 1 |
| 1 | 1 | −1 | 1 | −1 | 1 | −1 |
| 8 | 1 | −1 | −1 | 1 | 0 | 0 |
| 9 | 1 | 1 | −1 | −1 | 0 | 0 |

In this way, orthogonality can be achieved within a RB regardless the number of scheduled RBs.

### Example Processes for DMRS Transmission Type 2

As discussed above, in the following release 18, more orthogonal DMRS ports will be introduced. Specifically, the number of antenna ports for DMRS type 2 transmission is expected to be increased up to 24. According to some example embodiments of the present disclosure, how to how to design the CS will be discussed in detail.

In some embodiments, the terminal device 120 (and the network device 110) determines at least one FD-OCC for a DMRS type 2 transmission via more than twelve antenna ports (such as, 24 antenna ports). In particular, a length of the at least one FD-OCC is 4. Below Table 12 illustrates a mapping structure for the DMRS type 2.

Table 12 illustrates a mapping structure for the DMRS type 2

| | Port | Port | Port | Port | Port | Port | Port | Port | Port | Port | Port | Port |
|---|---|---|---|---|---|---|---|---|---|---|---|---|
| RE | 0/6 | 1/7 | 2/8 | 3/9 | 4/10 | 5/11 | 12/18 | 13/19 | 14/20 | 15/21 | 16/22 | 17/23 |
| 11 | 0 | 0 | 0 | 0 | 1 | −1 | 0 | 0 | 0 | 0 | −1 | 1 |
| 10 | 0 | 0 | 0 | 0 | 1 | 1 | 0 | 0 | 0 | 0 | −1 | −1 |
| 9 | 0 | 0 | 1 | −1 | 0 | 0 | 0 | 0 | 0 | 0 | 1 | −1 |
| 8 | 0 | 0 | 1 | 1 | 0 | 0 | 0 | 0 | 0 | 0 | 1 | 1 |
| 7 | 1 | −1 | 0 | 0 | 0 | 0 | 0 | 0 | −1 | 1 | 0 | 0 |
| 6 | 1 | 1 | 0 | 0 | 0 | 0 | 0 | 0 | −1 | −1 | 0 | 0 |
| 5 | 0 | 0 | 0 | 0 | 1 | −1 | 0 | 0 | 1 | −1 | 0 | 0 |
| 4 | 0 | 0 | 0 | 0 | 1 | 1 | 0 | 0 | 1 | 1 | 0 | 0 |
| 3 | 0 | 0 | 1 | −1 | 0 | 0 | −1 | 1 | 0 | 0 | 0 | 0 |
| 2 | 0 | 0 | 1 | 1 | 0 | 0 | −1 | −1 | 0 | 0 | 0 | 0 |
| 1 | 1 | −1 | 0 | 0 | 0 | 0 | 1 | −1 | 0 | 0 | 0 | 0 |
| 0 | 1 | 1 | 0 | 0 | 0 | 0 | 1 | 1 | 0 | 0 | 0 | 0 |

Below Table 13 illustrates another mapping structure for the DMRS type 2.

Table 13 illustrates a mapping structure for the DMRS type 2

| | Port | Port | Port | Port | Port | Port | Port | Port | Port | Port | Port | Port |
|---|---|---|---|---|---|---|---|---|---|---|---|---|
| RE | 0/6 | 1/7 | 2/8 | 3/9 | 4/10 | 5/11 | 12/18 | 13/19 | 14/20 | 15/21 | 16/22 | 17/23 |
| 11 | 0 | 0 | 0 | 0 | 1 | −1 | 0 | 0 | 0 | 0 | −1 | 1 |
| 10 | 0 | 0 | 0 | 0 | 1 | 1 | 0 | 0 | 0 | 0 | −1 | −1 |
| 9 | 0 | 0 | 1 | −1 | 0 | 0 | 0 | 0 | 0 | 0 | 1 | −1 |
| 8 | 0 | 0 | 1 | 1 | 0 | 0 | 0 | 0 | 0 | 0 | 1 | 1 |
| 7 | 1 | −1 | 0 | 0 | 0 | 0 | 0 | 0 | −1 | 1 | 0 | 0 |
| 6 | 1 | 1 | 0 | 0 | 0 | 0 | 0 | 0 | −1 | −1 | 0 | 0 |
| 5 | 0 | 0 | 0 | 0 | 1 | −1 | 0 | 0 | 1 | −1 | 0 | 0 |
| 4 | 0 | 0 | 0 | 0 | 1 | 1 | 0 | 0 | 1 | 1 | 0 | 0 |
| 3 | 0 | 0 | 1 | −1 | 0 | 0 | −1 | 1 | 0 | 0 | 0 | 0 |
| 2 | 0 | 0 | 1 | 1 | 0 | 0 | −1 | −1 | 0 | 0 | 0 | 0 |
| 1 | 1 | −1 | 0 | 0 | 0 | 0 | 1 | −1 | 0 | 0 | 0 | 0 |
| 0 | 1 | 1 | 0 | 0 | 0 | 0 | 1 | 1 | 0 | 0 | 0 | 0 |

In the above Table 13, the mapping structure for ports 1-11 is the same with the currently-proposed mapping structure. In this way, better backward compatibility may be achieved.

Below Table 14 illustrates a further mapping structure for the DMRS type 2.

Table 14 illustrates a mapping structure for the DMRS type 2

| | Port | Port | Port | Port | Port | Port | Port | Port | Port | Port | Port | Port |
|---|---|---|---|---|---|---|---|---|---|---|---|---|
| RE | 0/6 | 1/7 | 2/8 | 3/9 | 4/10 | 5/11 | 12/18 | 13/19 | 14/20 | 15/21 | 16/22 | 17/23 |
| 11 | 0 | 0 | 0 | 0 | 1 | −1 | 0 | 0 | 0 | 0 | −1 | 1 |
| 10 | 0 | 0 | 0 | 0 | 1 | 1 | 0 | 0 | 0 | 0 | −1 | −1 |
| 9 | 0 | 0 | 0 | 0 | 1 | −1 | 0 | 0 | 0 | 0 | 1 | −1 |
| 8 | 0 | 0 | 0 | 0 | 1 | 1 | 0 | 0 | 0 | 0 | 1 | 1 |
| 7 | 0 | 0 | 1 | −1 | 0 | 0 | 0 | 0 | −1 | 1 | 0 | 0 |
| 6 | 0 | 0 | 1 | 1 | 0 | 0 | 0 | 0 | −1 | −1 | 0 | 0 |
| 5 | 0 | 0 | 1 | −1 | 0 | 0 | 0 | 0 | 1 | −1 | 0 | 0 |
| 4 | 0 | 0 | 1 | 1 | 0 | 0 | 0 | 0 | 1 | 1 | 0 | 0 |
| 3 | 1 | −1 | 0 | 0 | 0 | 0 | −1 | 1 | 0 | 0 | 0 | 0 |
| 2 | 1 | 1 | 0 | 0 | 0 | 0 | −1 | −1 | 0 | 0 | 0 | 0 |
| 1 | 1 | −1 | 0 | 0 | 0 | 0 | 1 | −1 | 0 | 0 | 0 | 0 |
| 0 | 1 | 1 | 0 | 0 | 0 | 0 | 1 | 1 | 0 | 0 | 0 | 0 |

In the above Table 14, the mapping structure for ports 1-11 has been re-defined. In view of this, such DMRS transmission also may be referred to as a new DMRS type, for example, DMRS type 3.

According to the above example processes, more orthogonal DMRS ports may be achieved.

### Example Processes for Indicating DMRS Information

In order to achieve more flexible schedule and support more DMRS antenna ports, the network device 110 may indicate DMRS information to the terminal device 120.

In some embodiments, the network device 110 may transmit a configuration for a DMRS transmission to the terminal device 120. Further, the configuration may be comprised in an RRC message, DCI message, MAC CE message or any suitable message.

In some embodiments, the configuration indicates information about a length of FD-OCC corresponding to at least one antenna port configured for the at least one antenna port. In one specific example embodiment, the configuration indicates information about one or more downlink DMRS port(s) and a length of OCC (either TD-OCC or FD-OCC). By jointly indicating the downlink DMRS port(s) and length of OCC, the terminal device may well understand the interference cancellation information. For example, a first indication indicates DMRS ports (0, 1) with FD-OCC=2, and a second indication indicates DMRS ports (0, 1) with FD-OCC=4 (or with CS values {0, 6}). If the terminal device 120 receives the second indication, the terminal device 120 will understand that the current DMRS transmission is performed with more DMRS ports, and the terminal device 120 may perform interference cancellation for the newly-introduced DMRS ports.

Alternatively, or in addition, in some other embodiments, the configuration indicates information about antenna port group to be scheduled for the DMRS transmission. Specifically, a concept of DMRS port groups may be introduced. For example, for DMRS type 1, there may be two groups, i.e., DMRS port group 1 with ports {0-7}, DMRS port group 2 with ports {8-15}. For DMRS type 2, there may be two groups, i.e., DMRS port group 1 with ports {0-11}, DMRS port group 2 with ports {12-23}.

After receiving the information about the DMRS port group, the DMRS port indication table may be applied accordingly. In this way, the signalling overhead is reduced.

### Example Processes for Indicating Phase Tracking RS (PTRS)

Currently, the PTRS is introduced to enable compensation of oscillator phase noise. As discussed above, the number of antenna ports for DMRS type 1 transmission is expected to be increased up to 16 and the number of antenna ports for DMRS type 2 transmission is expected to be increased up to 24. In this event, how to configure the PTRS resource (i.e., PTRS ports) for the newly-introduced antenna ports is needed to be discussed.

In some embodiments, a port of the PTRS may correspond to one or more DMRS ports, and the DMRS port to which the PTRS port is mapped may be indicated by the information indicating an offset of a RE to which the PTRS is mapped. Further, the information may be comprised in an RRC message.

Below Tables 15 and 16 illustrate associations between DMRS antenna port and RE offset for DMRS type 1 transmission.

TABLE 15
example associations between DMRS antenna port
and RE offset for DMRS type 1 transmission

| DMRS | k_{ref}^{RE} | | | |
|---|---|---|---|---|
| antenna | DM-RS Configuration type 1 | | | |
| port | resourceElementOffset | | | |
| p | offset00 | offset01 | offset10 | offset11 |
| 1000 | 0 | 2 | 6 | 8 |
| 1001 | 2 | 4 | 8 | 10 |
| 1002 | 1 | 3 | 7 | 9 |
| 1003 | 3 | 5 | 9 | 11 |
| 1004 | — | — | — | — |
| 1005 | — | — | — | — |
| 1008 | 6 | 8 | 0 | 2 |
| 1009 | 8 | 10 | 2 | 4 |
| 1010 | 7 | 9 | 1 | 3 |
| 1011 | 9 | 11 | 3 | 5 |

TABLE 16
other example associations between DMRS antenna
port and RE offset for DMRS type 1 transmission

| DM-RS | k_{ref}^{RE} | | | |
|---|---|---|---|---|
| antenna | DM-RS Configuration type 1 | | | |
| port | resourceElementOffset | | | |
| p | offset00 | offset01 | offset10 | offset11 |
| 1000 | 0 | 2 | 6 | 8 |
| 1001 | 2 | 4 | 8 | 10 |
| 1002 | 1 | 3 | 7 | 9 |
| 1003 | 3 | 5 | 9 | 11 |
| 1004 | — | — | — | — |
| 1005 | — | — | — | — |
| 1008 | 6 | 8 | 0 | 2 |
| 1009 | 8 | 10 | 2 | 4 |
| 1010 | 7 | 9 | 1 | 3 |
| 1011 | 9 | 11 | 3 | 5 |

TABLE 17
example associations between DMRS antenna port
and RE offset for DMRS type 2 transmission

| DM-RS | k_{ref}^{RE} | | | |
|---|---|---|---|---|
| antenna | DM-RS Configuration type 2 | | | |
| port | resourceElementOffset | | | |
| p | offset00 | offset01 | offset10 | offset11 |
| 1000 | 0 | 1 | 6 | 7 |
| 1001 | 1 | 6 | 7 | 0 |
| 1002 | 2 | 3 | 8 | 9 |
| 1003 | 3 | 8 | 9 | 2 |
| 1004 | 4 | 5 | 10 | 11 |
| 1005 | 5 | 10 | 11 | 4 |
| 1012 | 6 | 7 | 0 | 1 |
| 1013 | 7 | 0 | 1 | 6 |
| 1014 | 8 | 9 | 2 | 3 |
| 1015 | 9 | 2 | 3 | 8 |
| 1016 | 10 | 11 | 4 | 5 |
| 1017 | 11 | 4 | 5 | 10 |

In this way, the oscillator phase noise may be well cancelled for the newly-introduced DMRS antenna ports.

### Example Methods

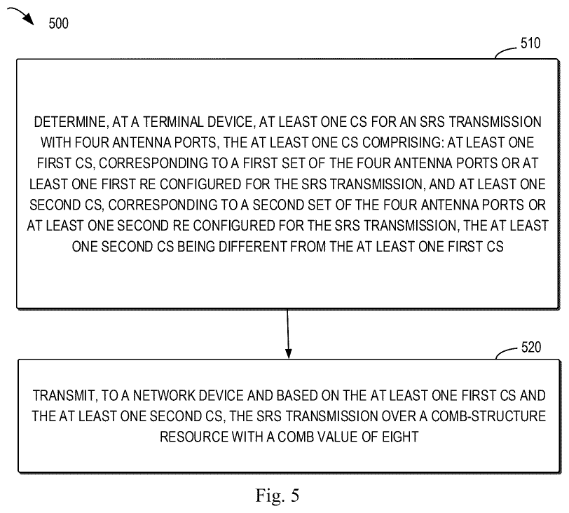

FIG. 5 illustrates a flowchart of an example method 500 in accordance with some embodiments of the present disclosure. For example, the method 500 can be implemented at the terminal device 120 as shown in FIG. 1.

At block 510, the terminal device 120 determines at least one CS for an SRS transmission with four antenna ports, the at least one CS comprising: at least one first CS, corresponding to a first set of the four antenna ports or at least one first set of REs configured for the SRS transmission, and at least one second CS, corresponding to a second set of the four antenna ports or at least one second set of REs configured for the SRS transmission, the at least one second CS being different from the at least one first CS.

At block 510, the terminal device 120 transmits, to a network device 110 and based on the at least one first CS and the at least one second CS, the SRS transmission over a comb-structure resource with a comb value of 8.

In some embodiments, the terminal device 120 determines an offset value for calculating either the at least one first CS or the at least one second CS, such that the at least one second CS is different with the at least one first CS.

In some embodiments, the offset value is predefined or determined from a configuration from the network device 110.

In some embodiments, a maximum number of values of the at least one CS is six.

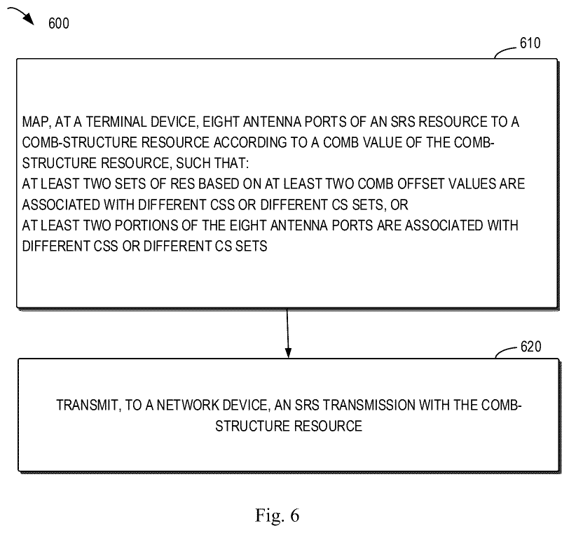

FIG. 6 illustrates a flowchart of an example method 600 in accordance with some embodiments of the present disclosure. For example, the method 600 can be implemented at the terminal device 120 as shown in FIG. 1.

At block 610, the terminal device 120 maps eight antenna ports of an SRS resource to a comb-structure resource according to a comb value of the comb-structure resource, such that: at least two sets of REs based on a first comb offset and a second comb offset are associated with different CSs or different CS sets, or at least two portions of the eight antenna ports are associated with different CSs or different CS sets.

At block 620, the terminal device 120 transmits, to a network device 110, a SRS transmission with the comb-structure resource.

In some embodiments, the at least two sets of REs are neighboring Res.

In some embodiments, a comb value of the comb-structure resource is one of the following {2, 4, 8}.

In some embodiments, a maximum number of values of the different CSs is 8 if the comb value of comb-structure resource is 2, a maximum number of values of the different CSs is 12 if the comb value of comb-structure resource is 4 and a maximum number of values of the different CSs is 6 if the comb value of comb-structure resource is 8.

In some embodiments, if the comb value of the comb-structure resource is 2, the terminal device 120 maps a first portion of the eight antenna ports to a first set of REs based on a first comb offset, the first portion of the eight antenna ports or the first set of REs being associated with a first CS set and maps a second portion of the eight antenna ports to a second set of REs based on a second comb offset, the second portion of the eight antenna ports or the second set of REs being associated with a second CS set being the same or different from the first CS set.

In some embodiments, if the comb value of the comb-structure resource is 2, the terminal device 120 maps the eight antenna ports to same REs, each antenna port of the eight antenna ports being associated with a respective CS.

In some embodiments, the terminal device 120 maps four antenna port sets of the eight antenna ports to four different sets of REs based on four comb offset values, respectively. Further, each of the four antenna port sets comprises two antenna ports, and different antenna port sets of the four antenna port sets or different set of REs are associated with different CS sets.

In some embodiments, if the comb value of the comb-structure resource is 4, the terminal device 120 maps two antenna port sets of the eight antenna ports to two different sets of REs based on a first comb offset and a second comb offset. Further, each of the two antenna port sets comprises four antenna ports, and different antenna port sets of the two antenna port sets or different set of REs are associated with different CS sets.

In some embodiments, if the comb value of the comb-structure resource is 8, the terminal device 120 maps the eight antenna ports to eight different set of REs based on eight respective comb offset values.

In some embodiments, if the comb value of the comb-structure resource is 8, the terminal device 120 maps two antenna port sets of the eight antenna ports to two different sets of REs based on a first comb offset and a second comb offset. Further, each of the two antenna port sets comprises four antenna ports, and different antenna port sets of the two antenna port sets or different sets of REs are associated with different CS sets.

In some embodiments, if the comb value of the comb-structure resource is 8, the terminal device 120 maps four antenna port sets of the eight antenna ports to four different sets of REs based on four respective comb offset values. Further, each of the four antenna port sets comprises two antenna ports, and different antenna port sets of the four antenna port sets or different sets of REs are associated with different CS sets.

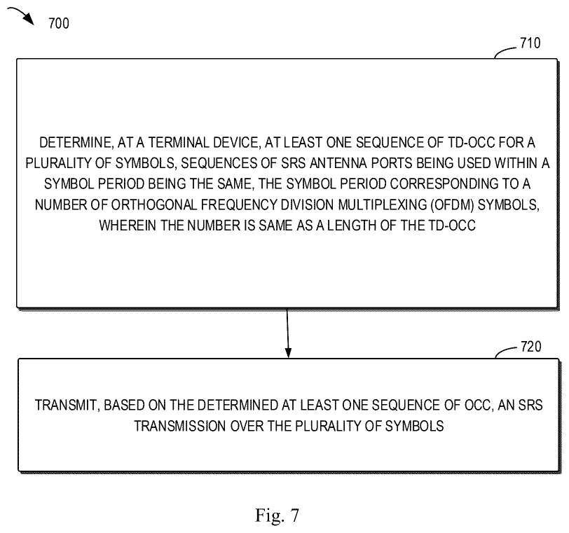

FIG. 7 illustrates a flowchart of an example method 700 in accordance with some embodiments of the present disclosure. For example, the method 700 can be implemented at the terminal device 120 as shown in FIG. 1.

At block 710, the terminal device 120 determines at least one value of TD-OCC for a plurality of symbols, sequences of the SRS antenna ports being used within a symbol period being the same, the symbol period corresponding to a number of OFDM symbols based on a length of the TD-OCC.

At block 720, the terminal device 120 transmits, based on the determined at least one value of OCC, an SRS transmission over the plurality of symbols.

In some embodiments, the terminal device 120 determines the at least one sequence of TD-OCC based on at least one of the following: the length of the TD-OCC, a UE specific parameter, a cell specific parameter, or an interference randomization parameter for a group hopping or a sequence hopping.

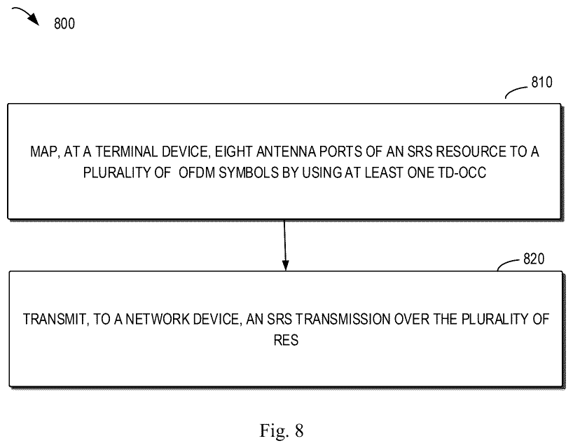

FIG. 8 illustrates a flowchart of an example method 800 in accordance with some embodiments of the present disclosure. For example, the method 800 can be implemented at the terminal device 120 as shown in FIG. 1.

At block 810, the terminal device 120 maps eight antenna ports of an SRS resource to a plurality of REs and/or a plurality of OFDM symbols by using at least one TD-OCC.

At block 820, the terminal device 120 transmits, to a network device 110, a SRS transmission over the plurality of REs and/or the plurality of OFDM symbols.

In some embodiments, the terminal device 120 maps a first four antenna ports based on a first TD-OCC, and maps a second four antenna ports based on a second TD-OCC, a length of the first and the second TD-OCCs being 2.

In some embodiments, the terminal device 120 maps four antenna port sets of the eight antenna ports based on four different TD-OCCs with a length of 4, each of the four antenna port sets comprising two antenna ports.

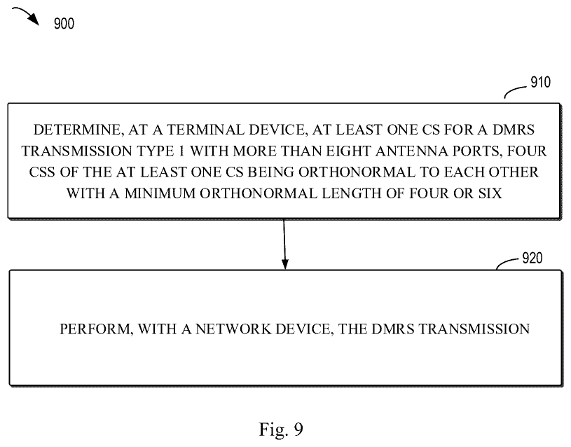

FIG. 9 illustrates a flowchart of an example method 900 in accordance with some embodiments of the present disclosure. For example, the method 900 can be implemented at the terminal device 120 as shown in FIG. 1.

At block 910, the terminal device 120 determines at least one CS for a DMRS transmission type 1 with more than eight antenna ports, four CSs of the at least one CS being orthonormal to each other with a minimum orthonormal length of four or six.

At block 910, the terminal device 120 performs, with a network device 110, the DMRS transmission.

In some embodiments, if a number of scheduled RBs is an odd number, the orthonormal length is 6, or if a number of scheduled RBs is an even number, the orthonormal length is 4.

In some embodiments, the terminal device 120 receives, from the network device 110, a configuration indicating: information about at least one antenna port for the DMRS transmission, and information about at least one cyclic shift value corresponding to the at least one antenna port.

In some embodiments, if a maximum number of values of the at least one CS is 6, a set of CS values is one of the following: {0, 1, 3, 4} or {0, 2, 3, 5}.

In some embodiments, if a maximum number of values of the at least one CS is 12, a set of CS values is one of the following: {0, 2, 6, 8} or {0, 4, 6, 10}, {0, 3, 6, 9}.

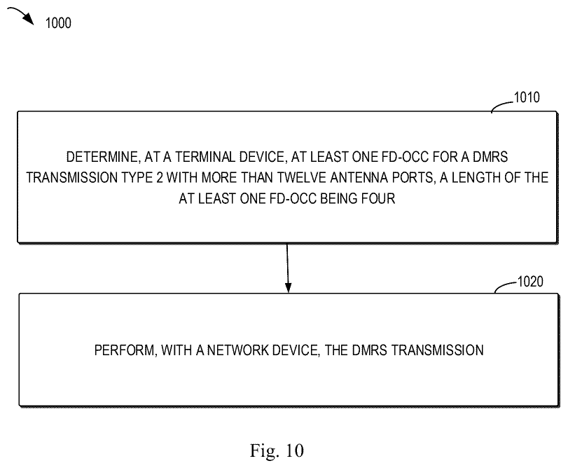

FIG. 10 illustrates a flowchart of an example method 1000 in accordance with some embodiments of the present disclosure. For example, the method 1000 can be implemented at the terminal device 120 as shown in FIG. 1.

At block 1010, the terminal device 120 determines at least one FD-OCC for a DMRS transmission type 2 with more than twelve antenna ports, a length of the at least one FD-OCC being four.

At block 1020, the terminal device 120 performs, with a network device 110, the DMRS transmission.

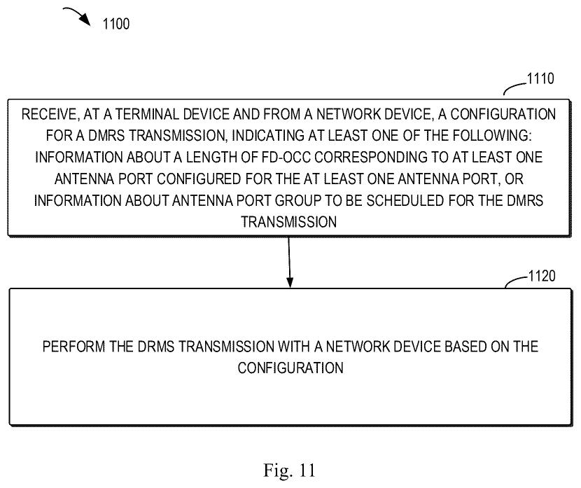

FIG. 11 illustrates a flowchart of an example method 1100 in accordance with some embodiments of the present disclosure. For example, the method 1100 can be implemented at the terminal device 120 as shown in FIG. 1.

At block 1110, the terminal device 120 receives, from a network device 110, a configuration for a DMRS transmission, indicating at least one of the following: information about a length of FD-OCC corresponding to at least one antenna port configured for the at least one antenna port, or information about antenna port group to be scheduled for the DMRS transmission.

At block 1120, the terminal device 120 performs the DRMS transmission with a network device 110 based on the configuration.

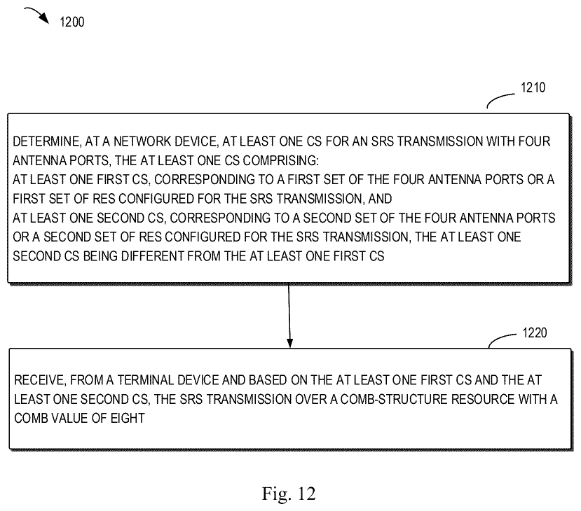

FIG. 12 illustrates a flowchart of an example method 1200 in accordance with some embodiments of the present disclosure. For example, the method 1200 can be implemented at the network device 110 as shown in FIG. 1.

At block 1210, the network device 110 determines at least one CS for an SRS transmission with four antenna ports, the at least one CS comprising: at least one first CS, corresponding to a first set of the four antenna ports or a first set of REs configured for the SRS transmission, and at least one second CS, corresponding to a second set of the four antenna ports or a second set of REs configured for the SRS transmission, the at least one second CS being different from the at least one first CS.

At block 1220, the network device 110 receives, from a terminal device 120 and based on the at least one first CS and the at least one second CS, the SRS transmission over a comb-structure resource with a comb value of 8.

In some embodiments, the network device 110 determines an offset value for calculating either the at least one first CS or the at least one second CS, such that the at least one second CS is different with the at least one first CS.

In some embodiments, the offset value is predefined or determined by the network device 110.

In some embodiments, a maximum number of values of the at least one cyclic shift is six.

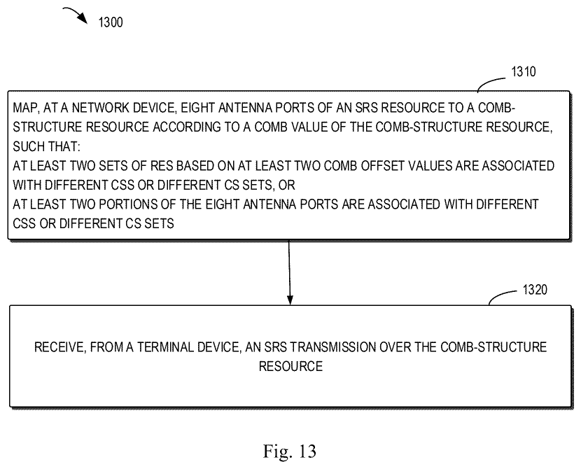

FIG. 13 illustrates a flowchart of an example method 1300 in accordance with some embodiments of the present disclosure. For example, the method 1300 can be implemented at the network device 110 as shown in FIG. 1.

At block 1310, the network device 110 maps eight antenna ports of an SRS resource to a comb-structure resource according to a comb value of the comb-structure resource, such that: at least two sets of REs based on at least two comb offset values are associated with different CSs or different CS sets, or at least two portions of the eight antenna ports are associated with different CSs or different CS sets.

At block 1320, the network device 110 receives, from a terminal device 120, a SRS transmission over the comb-structure resource.

In some embodiments, the at least two sets of REs are neighboring REs.

In some embodiments, a comb value of the comb-structure resource is one of the following {2, 4, 8}.

In some embodiments, a maximum number of values of the different CSs is 8 if the comb value of comb-structure resource is 2, a maximum number of values of the different CSs is 12 if the comb value of comb-structure resource is 4, and a maximum number of values of the different CSs is 6 if the comb value of comb-structure resource is 8.

In some embodiments, if the comb value of the comb-structure resource is 2, the network device 110 maps a first portion of the eight antenna ports to a first set of REs based on a first comb offset, the first portion of the eight antenna ports or the first set of REs being associated with a first CS set, and maps a second portion of the eight antenna ports to a second set of REs based on a second comb offset, the second portion of the eight antenna ports or the second set of REs being associated with a second CS set being the same or different from the first CS set.

In some embodiments, if the comb value of the comb-structure resource is 2, the network device 110 maps the eight antenna ports to same REs, each antenna port of the eight antenna ports being associated with a respective CS.

In some embodiments, if the comb value of the comb-structure resource is 4, the network device 110 maps four antenna port sets of the eight antenna ports to four different sets of REs based on four respective comb offset values. Further, each of the four antenna port sets comprises two antenna ports, and different antenna port sets of the four antenna port sets or the four sets of REs are associated with different CS sets.

In some embodiments, if the comb value of the comb-structure resource is 4, the network device 110 maps two antenna port sets of the eight antenna ports to two different sets of REs based on a first comb offset and a second comb offset. Further, each of the two antenna port sets comprises four antenna ports, and different antenna port sets of the two antenna port sets or different sets of REs are associated with different CS sets.

In some embodiments, if the comb value of the comb-structure resource is 8, the network device 110 maps the eight antenna ports to eight different sets of REs based on eight respective comb offset values.

In some embodiments, if the comb value of the comb-structure resource is 8, the network device 110 maps two antenna port sets of the eight antenna ports to two different sets of REs based on a first comb offset and a second comb offset. Further, each of the two antenna port sets comprises four antenna ports and different antenna port sets of the two antenna port sets or different sets of REs are associated with different CS sets.

In some embodiments, if the comb value of the comb-structure resource is 8, the network device 110 maps four antenna port sets of the eight antenna ports to four different sets of REs based on four respective comb offset. Further, each of the four antenna port sets comprises two antenna ports; and different antenna port sets of the four antenna port sets or different sets of REs are associated with different CS sets.

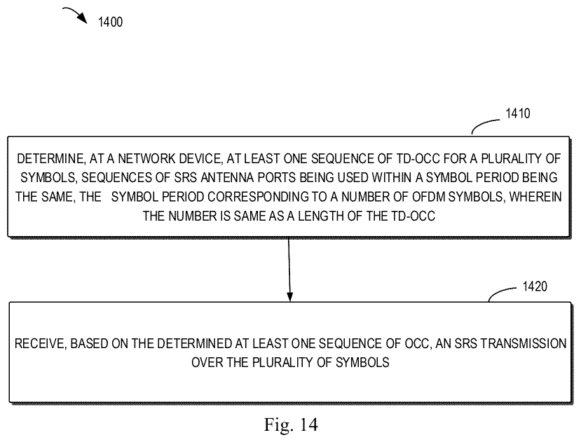

FIG. 14 illustrates a flowchart of an example method 1400 in accordance with some embodiments of the present disclosure. For example, the method 1400 can be implemented at the network device 110 as shown in FIG. 1.

At block 1410, the network device 110 determines at least one sequence of TD-OCC for a plurality of symbols, sequences of the SRS antenna ports being used within a symbol period being the same, the symbol period corresponding to a number of OFDM symbols based on a length of the TD-OCC.

At block 1420, the network device 110 receives, based on the determined at least one value of OCC, an SRS transmission over the plurality of symbols.

In some embodiments, the network device 110 determines the at least one at least one sequence of TD-OCC based on at least one of the following: the length of the TD-OCC, a UE specific parameter, a cell specific parameter, or an interference randomization parameter for a group hopping or a sequence hopping.

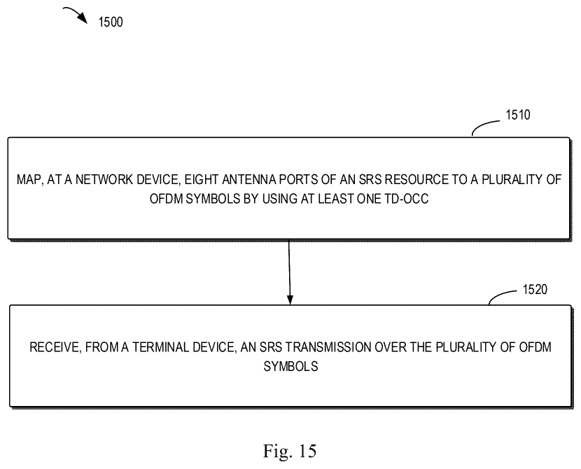

FIG. 15 illustrates a flowchart of an example method 1500 in accordance with some embodiments of the present disclosure. For example, the method 1500 can be implemented at the network device 110 as shown in FIG. 1.

At block 1510, the network device 110 maps eight antenna ports of an SRS resource to a plurality of REs and/or a plurality of OFDM symbols by using at least one TD-OCC.

At block 1520, the network device 110 receives, from a terminal device 120, a SRS transmission over the plurality of REs and/or the plurality of OFDM symbols.

In some embodiments, the network device 110 maps a first four antenna ports based on a first TD-OCC, and maps a second four antenna ports based on a second TD-OCC, a length of the first and the second TD-OCCs being 2.

In some embodiments, the network device 110 maps four antenna port sets of the eight antenna ports based on four different TD-OCCs with a length of 4, each of the four antenna port sets comprising two antenna ports.

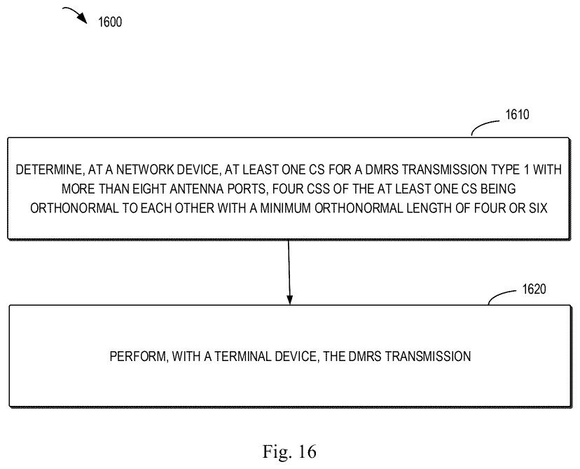

FIG. 16 illustrates a flowchart of an example method 1600 in accordance with some embodiments of the present disclosure. For example, the method 1600 can be implemented at the network device 110 as shown in FIG. 1.

At block 1610, the network device 110 determines at least one CS for a DMRS transmission type 1 with more than eight antenna ports, four CSs of the at least one CS being orthonormal to each other with a minimum orthonormal length of four or six.

At block 1620, the network device 110 performs, with a terminal device 120, the DMRS transmission.

In some embodiments, if a number of scheduled RBs is an odd number, the orthonormal length is 6, or if a number of scheduled RBs is an even number, the orthonormal length is 4.

In some embodiments, the network device 110 transmits, to the terminal device 120, a configuration indicating: information about at least one antenna port for the DMRS transmission, and information about at least one CS value corresponding to the at least one antenna port.

In some embodiments, if a maximum number of values of the at least one CS is 6, a set of CS values is one of the following: {0, 1, 3, 4} or {0, 2, 3, 5}.

In some embodiments, if a maximum number of values of the at least one CS is 12, a set of VS values is one of the following: {0, 2, 6, 8} or {0, 4, 6, 10}, {0, 3, 6, 9}.

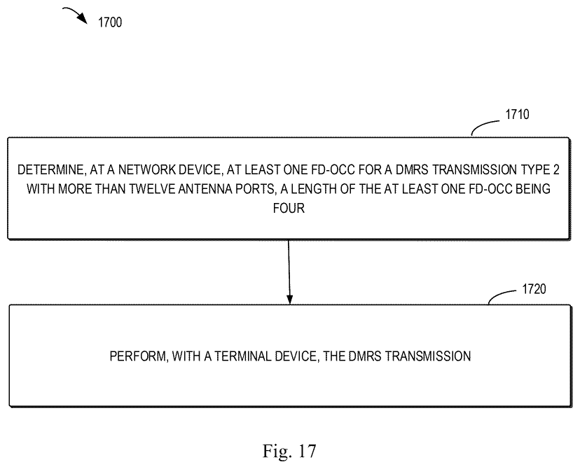

FIG. 17 illustrates a flowchart of an example method 1700 in accordance with some embodiments of the present disclosure. For example, the method 1700 can be implemented at the network device 110 as shown in FIG. 1.

At block 1710, the network device 110 determines at least one FD-OCC for a DMRS transmission type 2 with more than twelve antenna ports, a length of the at least one FD-OCC being four.

At block 1720, the network device 110 performs, with a terminal device 120, the DMRS transmission.

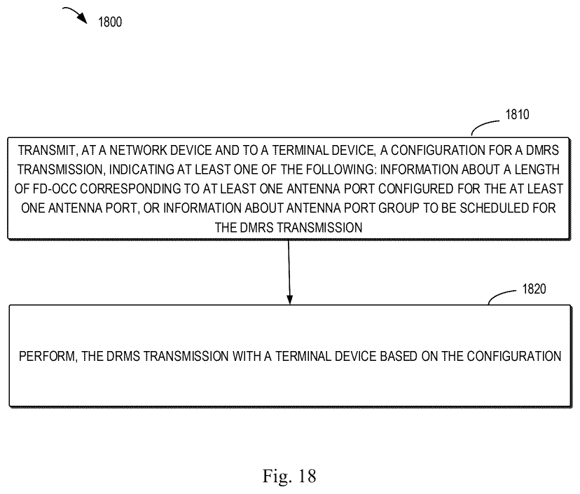

FIG. 18 illustrates a flowchart of an example method 1800 in accordance with some embodiments of the present disclosure. For example, the method 1800 can be implemented at the network device 110 as shown in FIG. 1.

At block 1810, the network device 110 transmits, to a terminal device 120, a configuration for a DMRS transmission, indicating at least one of the following: information about a length of FD-OCC corresponding to at least one antenna port configured for the at least one antenna port, or information about antenna port group to be scheduled for the DMRS transmission.

At block 1820, the network device 110 performs, the DRMS transmission with a terminal device 120 based on the configuration.

### Example Devices

In some example embodiments, the terminal device 120 comprises circuitry configured to: determine at least one CS for an SRS transmission with four antenna ports, the at least one CS comprising: at least one first CS, corresponding to a first set of the four antenna ports or at least one first RE configured for the SRS transmission, and at least one second CS, corresponding to a second set of the four antenna ports or at least one second RE configured for the SRS transmission, the at least one second CS being different from the at least one first CS; and transmit, to a network device 110 and based on the at least one first CS and the at least one second CS, the SRS transmission over a comb-structure resource with a comb value of eight.

In some embodiments, the circuitry is further configured to: determine an offset value for calculating either the at least one first CS or the at least one second CS, such that the at least one second CS is different with the at least one first CS.

In some embodiments, the offset value is predefined or determined from a configuration from the network device 110.

In some embodiments, a maximum number of values of the at least one CS is six.

In some example embodiments, the terminal device 120 comprises circuitry configured to: map eight antenna ports of an SRS resource to a comb-structure resource according to a comb value of the comb-structure resource, such that: at least two REs based on different comb offset values are associated with different CSs or different CS sets, or at least two portions of the eight antenna ports are associated with different CSs or different CS sets; and transmit, to a network device 110, a SRS transmission with the comb-structure resource.

In some embodiments, the at least two REs are two neighboring REs.

In some embodiments, a comb value of the comb-structure resource is one of the following {2, 4, 8}.

In some embodiments, a maximum number of values of the different CSs is 8 if the comb value of comb-structure resource is 2, a maximum number of values of the different CSs is 12 if the comb value of comb-structure resource is 4 and a maximum number of values of the different CSs is 6 if the comb value of comb-structure resource is 8.

In some embodiments, the circuitry is further configured to: if the comb value of the comb-structure resource is 2, map a first portion of the eight antenna ports to a first set of REs based on a first comb offset, the first portion of the eight antenna ports or the first set of REs being associated with a first CS set and map a second portion of the eight antenna ports to a second set of REs based on a second comb offset, the second portion of the eight antenna ports or the second set of REs being associated with a second CS set being the same or different from the first CS set.

In some embodiments, the circuitry is further configured to: if the comb value of the comb-structure resource is 2, map the eight antenna ports to same REs, each antenna port of the eight antenna ports being associated with a respective CS.

In some embodiments, the circuitry is further configured to: if the comb value of the comb-structure resource is 4, map four antenna port sets of the eight antenna ports to four different sets of REs based on four comb offset values respectively. Further, each of the four antenna port sets comprises two antenna ports, and different antenna port sets of the four antenna port sets or different sets of REs are associated with different CS sets.

In some embodiments, the circuitry is further configured to: if the comb value of the comb-structure resource is 4, map two antenna port sets of the eight antenna ports to two different sets of REs based on a first comb offset and a second comb offset. Further, each of the two antenna port sets comprises four antenna ports, and different antenna port sets of the two antenna port sets or different sets of REs are associated with different CS sets.

In some embodiments, the circuitry is further configured to: if the comb value of the comb-structure resource is 8, map the eight antenna ports to eight different sets of REs based on eight comb offset values respectively.

In some embodiments, the circuitry is further configured to: if the comb value of the comb-structure resource is 8, map two antenna port sets of the eight antenna ports to two different sets of REs based on a first comb offset and a second comb offset. Further, each of the two antenna port sets comprises four antenna ports, and different antenna port sets of the two antenna port sets or different sets of REs are associated with different CS sets.

In some embodiments, the circuitry is further configured to: if the comb value of the comb-structure resource is 8, map four antenna port sets of the eight antenna ports to four different sets of REs based on four comb offset values respectively. Further, each of the four antenna port sets comprises two antenna ports, and different antenna port sets of the four antenna port sets or different sets of REs are associated with different CS sets.

In some example embodiments, the terminal device 120 comprises circuitry configured to: determine at least one sequence of TD-OCC for a plurality of symbols, sequences of the SRS antenna ports being used within a symbol period being the same, the symbol period corresponding to a number of OFDM symbols based on a length of the TD-OCC; and transmit, based on the determined at least one value of OCC, an SRS transmission over the plurality of symbols.

In some embodiments, the circuitry is further configured to: determine the at least one at least one sequence of TD-OCC based on at least one of the following: the length of the TD-OCC, a UE specific parameter, a cell specific parameter, or an interference randomization parameter for a group hopping or a sequence hopping.

In some example embodiments, the terminal device 120 comprises circuitry configured to: map eight antenna ports of an SRS resource based on at least one TD-OCC; and transmit, to a network device 110, a SRS transmission over the plurality of ODFM symbols.

In some embodiments, the circuitry is further configured to: map a first four antenna ports based on a first TD-OCC, and map a second four antenna ports based on a second TD-OCC, a length of the first and the second TD-OCCs being 2.

In some embodiments, the circuitry is further configured to: map four antenna port sets of the eight antenna ports based on four different TD-OCCs with a length of 4, each of the four antenna port sets comprising two antenna ports.

In some example embodiments, the terminal device 120 comprises circuitry configured to: determine at least one CS for a DMRS transmission type 1 with more than eight antenna ports, four CSs of the at least one CS being orthonormal to each other with a minimum orthonormal length of four or six; and perform, with a network device 110, the DMRS transmission.

In some embodiments, if a number of scheduled RBs is an odd number, the orthonormal length is 6, or if a number of scheduled RBs is an even number, the orthonormal length is 4.

In some embodiments, the circuitry is further configured to: receive, from the network device 110, a configuration indicating: information about at least one antenna port for the DMRS transmission, and information about at least one cyclic shift value corresponding to the at least one antenna port.

In some embodiments, if a maximum number of values of the at least one CS is 6, a set of CS values is one of the following: {0, 1, 3, 4} or {0, 2, 3, 5}.

In some embodiments, if a maximum number of values of the at least one CS is 12, a set of CS values is one of the following: {0, 2, 6, 8} or {0, 4, 6, 10}, {0, 3, 6, 9}.

In some example embodiments, the terminal device 120 comprises circuitry configured to: determine at least one FD-OCC for a DMRS transmission type 2 with more than twelve antenna ports, a length of the at least one FD-OCC being four; and perform, with a network device 110, the DMRS transmission.

In some example embodiments, the terminal device 120 comprises circuitry configured to: receive, from a network device 110, a configuration for a DMRS transmission, indicating at least one of the following: information about a length of FD-OCC corresponding to at least one antenna port configured for the at least one antenna port, or information about antenna port group to be scheduled for the DMRS transmission; and perform the DRMS transmission with a network device 110 based on the configuration.

In some example embodiments, the network device 110 comprises circuitry configured to: determine at least one CS for an SRS transmission with four antenna ports, the at least one CS comprising: at least one first CS, corresponding to a first set of the four antenna ports or at least one first RE configured for the SRS transmission, and at least one second CS, corresponding to a second set of the four antenna ports or at least one second RE configured for the SRS transmission, the at least one second CS being different from the at least one first CS; and receive, from a terminal device 120 and based on the at least one first CS and the at least one second CS, the SRS transmission over a comb-structure resource with a comb value of eight.

In some embodiments, the circuitry is further configured to: determine an offset value for calculating either the at least one first CS or the at least one second CS, such that the at least one second CS is different with the at least one first CS.

In some embodiments, the offset value is predefined or determined by the network device 110.

In some embodiments, a maximum number of values of the at least one cyclic shift is six.

In some example embodiments, the network device 110 comprises circuitry configured to: map eight antenna ports of an SRS resource to a comb-structure resource according to a comb value of the comb-structure resource, such that: at least two sets of REs based on different comb offset values are associated with different CSs or different CS sets, or at least two portions of the eight antenna ports are associated with different CSs or different CS sets; and receive, from a terminal device 120, a SRS transmission over the comb-structure resource.

In some embodiments, the at least two REs are two neighboring REs.

In some embodiments, a comb value of the comb-structure resource is one of the following {2, 4, 8}.

In some embodiments, a maximum number of values of the different CSs is 8 if the comb value of comb-structure resource is 2, a maximum number of values of the different CSs is 12 if the comb value of comb-structure resource is 4, and a maximum number of values of the different CSs is 6 if the comb value of comb-structure resource is 8.

In some embodiments, the circuitry is further configured to: if the comb value of the comb-structure resource is 2, map a first portion of the eight antenna ports to a first set of REs based on a first comb offset, the first portion of the eight antenna ports or the first set of REs being associated with a first CS set, and map a second portion of the eight antenna ports to a second set of REs based on a second comb offset, the second portion of the eight antenna ports or the second set of REs being associated with a second CS set being the same or different from the first CS set.

In some embodiments, the circuitry is further configured to: if the comb value of the comb-structure resource is 2, map the eight antenna ports to same REs, each antenna port of the eight antenna ports being associated with a respective CS.

In some embodiments, the circuitry is further configured to: if the comb value of the comb-structure resource is 4, map four antenna port sets of the eight antenna ports to four different sets of REs based on four comb offset values respectively. Further, each of the four antenna port sets comprises two antenna ports, and different antenna port sets of the four antenna port sets or different sets of REs are associated with different CS sets.

In some embodiments, the circuitry is further configured to: if the comb value of the comb-structure resource is 4, map two antenna port sets of the eight antenna ports to two different sets of REs based on a first comb offset and a second comb offset. Further, each of the two antenna port sets comprises four antenna ports, and different antenna port sets of the two antenna port sets or different sets of REs are associated with different CS sets.

In some embodiments, the circuitry is further configured to: if the comb value of the comb-structure resource is 8, map the eight antenna ports to eight different sets of REs based on eight comb offset values respectively.

In some embodiments, the circuitry is further configured to: if the comb value of the comb-structure resource is 8, map two antenna port sets of the eight antenna ports to two different sets of REs based on a first comb offset and a second comb offset. Further, each of the two antenna port sets comprises four antenna ports and different antenna port sets of the two antenna port sets or different sets of REs are associated with different CS sets.

In some embodiments, the circuitry is further configured to: if the comb value of the comb-structure resource is 8, map four antenna port sets of the eight antenna ports to four different sets of REs based on four comb offset values respectively. Further, each of the four antenna port sets comprises two antenna ports; and different antenna port sets of the four antenna port sets or different sets of REs are associated with different CS sets.

In some example embodiments, the network device 110 comprises circuitry configured to: determine at least one sequence of TD-OCC for a plurality of symbols, sequences of the SRS antenna ports being used within a symbol period being the same, the symbol period corresponding to a number of OFDM symbols based on a length of the TD-OCC; and receive, based on the determined at least one value of OCC, an SRS transmission over the plurality of symbols.

In some embodiments, the circuitry is further configured to: determine the at least one at least one sequence of TD-OCC based on at least one of the following: the length of the TD-OCC, a UE specific parameter, a cell specific parameter, or an interference randomization parameter for a group hopping or a sequence hopping.

In some example embodiments, the network device 110 comprises circuitry configured to: map eight antenna ports of an SRS resource to a plurality of REs and/or a plurality of OFDM symbols based on at least one TD-OCC; and receive, from a terminal device 120, a SRS transmission over the plurality of OFDM symbols.

In some embodiments, the circuitry is further configured to: map a first four antenna ports based on a first TD-OCC, and map a second four antenna ports based on a second TD-OCC, a length of the first and the second TD-OCCs being 2.

In some embodiments, the circuitry is further configured to: map four antenna port sets of the eight antenna ports based on four different TD-OCCs with a length of 4, each of the four antenna port sets comprising two antenna ports.

In some example embodiments, the network device 110 comprises circuitry configured to: determine at least one CS for a DMRS transmission type 1 with more than eight antenna ports, four CSs of the at least one CS being orthonormal to each other with a minimum orthonormal length of four or six; and perform, with a terminal device 120, the DMRS transmission.

In some embodiments, if a number of scheduled RBs is an odd number, the orthonormal length is 6, or if a number of scheduled RBs is an even number, the orthonormal length is 4.

In some embodiments, the circuitry is further configured to: transmit, to the terminal device 120, a configuration indicating: information about at least one antenna port for the DMRS transmission, and information about at least one CS value corresponding to the at least one antenna port.

In some embodiments, if a maximum number of values of the at least one CS is 6, a set of CS values is one of the following: {0, 1, 3, 4} or {0, 2, 3, 5}.

In some embodiments, if a maximum number of values of the at least one CS is 12, a set of VS values is one of the following: {0, 2, 6, 8} or {0, 4, 6, 10}, {0, 3, 6, 9}.

In some example embodiments, the network device 110 comprises circuitry configured to: determine at least one FD-OCC for a DMRS transmission type 2 with more than twelve antenna ports, a length of the at least one FD-OCC being four; and perform, with a terminal device 120, the DMRS transmission.

In some example embodiments, the network device 110 comprises circuitry configured to: transmit, to a terminal device 120, a configuration for a DMRS transmission, indicating at least one of the following: information about a length of FD-OCC corresponding to at least one antenna port configured for the at least one antenna port, or information about antenna port group to be scheduled for the DMRS transmission; and perform, the DRMS transmission with a terminal device 120 based on the configuration.

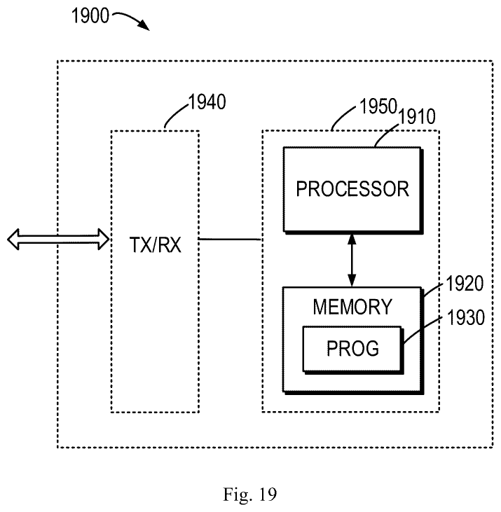

FIG. 19 is a simplified block diagram of a device 1900 that is suitable for implementing embodiments of the present disclosure. The device 1900 can be considered as a further example implementation of the terminal device 120 and the network device 110 as shown in FIG. 1. Accordingly, the device 1900 can be implemented at or as at least a part of the terminal 120 and the network devices 110.

As shown, the device 1900 includes a processor 1919, a memory 1920 coupled to the processor 1919, a suitable transmitter (TX) and receiver (RX) 1940 coupled to the processor 1919, and a communication interface coupled to the TX/RX 1940. The memory 1919 stores at least a part of a program 1930. The TX/RX 1940 is for bidirectional communications. The TX/RX 1940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1930 is assumed to include program instructions that, when executed by the associated processor 1910, enable the device 1900 to operate in accordance with the embodiments of the present disclosure, as discussed herein with reference to FIGS. 1-18. The embodiments herein may be implemented by computer software executable by the processor 1910 of the device 1900, or by hardware, or by a combination of software and hardware. The processor 1910 may be configured to implement various embodiments of the present disclosure. Furthermore, a combination of the processor 1910 and memory 1920 may form processing means 1950 adapted to implement various embodiments of the present disclosure.

The memory 1920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1920 is shown in the device 1900, there may be several physically distinct memory modules in the device 1900. The processor 1910 may be of any type suitable to the local technical network, and may include one or more of general purpose computers, special purpose computers, microprocessors, digital signal processors (DSPs) and processors based on multicore processor architecture, as non-limiting examples. The device 1900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 5-18. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
determining, at a terminal device, at least one cyclic shift (CS) for a sounding reference signal (SRS) transmission with four antenna ports, the at least one CS comprising:
at least one first CS, corresponding to a first set of the four antenna ports or a first set of resource elements (REs) configured for the SRS transmission, and
at least one second CS, corresponding to a second set of the four antenna ports or a second set of REs configured for the SRS transmission, the at least one second CS being different from the at least one first CS; and
transmitting, to a network device and based on the at least one first CS and the at least one second CS, the SRS transmission over a comb-structure resource with a comb value of eight.

2. The method of claim 1, wherein determining at least one CS comprises:
determining an offset value for calculating either the at least one first CS or the at least one second CS, such that the at least one second CS is different with the at least one first CS.

3. The method of claim 2, wherein the offset value is predefined or determined from a configuration from the network device.

4. The method of claim 1, wherein a maximum number of values of the at least one CS is six.

5. A method of communication, comprising:
mapping, at a terminal device, eight antenna ports of a sounding reference signal (SRS) resource to a comb-structure resource according to a comb value of the comb-structure resource, such that:
at least two sets of resource elements (REs) based on at least two comb offset values are associated with different cyclic shifts (CSs) or different CS sets, or
at least two portions of the eight antenna ports are associated with different CSs or different CS sets; and
transmitting, to a network device, a SRS transmission with the comb-structure resource.

6. The method of claim 5, wherein the at least two sets of REs are neighboring REs.

7. The method of claim 5, wherein a comb value of the comb-structure resource is one of the following {2, 4, 8}.

8. The method of claim 7, wherein,
a maximum number of values of the different CSs is 8 if the comb value of comb-structure resource is 2;
a maximum number of values of the different CSs is 12 if the comb value of comb-structure resource is 4; and
a maximum number of values of the different CSs is 6 if the comb value of comb-structure resource is 8.

9. The method of claim 7, wherein if the comb value of the comb-structure resource is 2, mapping the eight antenna ports comprises:
mapping a first portion of the eight antenna ports to a first set of REs based on a first comb offset, the first portion of the eight antenna ports or the first set of REs being associated with a first CS set; and
mapping a second portion of the eight antenna ports to a second set of REs based on a second comb offset, the second portion of the eight antenna ports or the second set of REs being associated with a second CS set being the same or different from the first CS set.

10. The method of claim 7, wherein if the comb value of the comb-structure resource is 2, mapping the eight antenna ports comprises:
mapping the eight antenna ports to same REs, each antenna port of the eight antenna ports being associated with a respective CS.

11. The method of claim 7, wherein if the comb value of the comb-structure resource is 4, mapping the eight antenna ports comprises:
mapping four antenna port sets of the eight antenna ports to four different sets of REs based on four respective comb offset values, wherein,
each of the four antenna port sets comprises two antenna ports; and
different antenna port sets of the four antenna port sets or different sets of REs are associated with different CS sets.

12. The method of claim 7, wherein if the comb value of the comb-structure resource is 4, mapping the eight antenna ports comprises:
mapping two antenna port sets of the eight antenna ports to two different sets of REs based on the first comb offset and the second comb offset, wherein,
each of the two antenna port sets comprises four antenna ports; and
different antenna port sets of the two antenna port sets or different sets of REs are associated with different CS sets.

13. The method of claim 7, wherein if the comb value of the comb-structure resource is 8, mapping the eight antenna ports comprises:
mapping the eight antenna ports to eight different sets of REs based on eight respective comb offset values.

14. The method of claim 7, wherein if the comb value of the comb-structure resource is 8, mapping the eight antenna ports comprises:
mapping two antenna port sets of the eight antenna ports to two different sets of REs based on the first comb offset and the second comb offset, wherein,
each of the two antenna port sets comprises four antenna ports; and
different antenna port sets of the two antenna port sets or different sets of REs are associated with different CS sets.

15. The method of claim 7, wherein if the comb value of the comb-structure resource is 8, mapping the eight antenna ports comprises:
mapping four antenna port sets of the eight antenna ports to four different sets of REs based on four respective comb offset values, wherein,
each of the four antenna port sets comprises two antenna ports; and
different antenna port sets of the four antenna port sets or different sets of REs are associated with different CS sets.

16. A method of communication, comprising:
determining, at a terminal device, at least one sequence of time domain orthogonal cover code (TD-OCC) for a plurality of symbols, sequences of sounding reference signal (SRS) antenna ports being used within a symbol period being the same, the symbol period corresponding to a number of orthogonal frequency division multiplexing (OFDM) symbols, wherein the number is same as a length of the TD-OCC; and
transmitting, based on the determined at least one sequence of OCC, a sounding reference signal (SRS) transmission over the plurality of symbols.

17. The method of claim 16, wherein determining the at least one sequence of TD-OCC comprises:
determining the at least one sequence of TD-OCC based on at least one of the following:
the length of the TD-OCC,
a user equipment (UE) specific parameter,
a cell specific parameter, or
an interference randomization parameter for a group hopping or a sequence hopping.

18. A method of communication, comprising:
mapping, at a terminal device, eight antenna ports of a sounding reference signal (SRS) resource to a plurality of orthogonal frequency division multiplexing (OFDM) symbols by using at least one time domain orthogonal cover code (TD-OCC); and
transmitting, to a network device, a SRS transmission over the plurality of OFDM symbols.

19. The method of claim 18, wherein mapping the eight antenna ports comprises:
mapping a first four antenna ports to the plurality of OFDM symbols by using a first TD-OCC; and
mapping a second four antenna ports to the plurality of OFDM symbols by using a second TD-OCC, a length of the first and the second TD-OCCs being 2.

20. The method of claim 18, wherein mapping the eight antenna ports comprises:
mapping four antenna port sets of the eight antenna ports to the plurality of OFDM symbols by using four different TD-OCCs with a length of 4, each of the four antenna port sets comprising two antenna ports.

21. A method of communication, comprising:
determining, at a terminal device, at least one cyclic shift (CS) for a demodulation reference signal (DMRS) transmission type 1 with more than eight antenna ports, four CSs of the at least one CS being orthonormal to each other with a minimum orthonormal length of four or six; and
performing, with a network device, the DMRS transmission.

22. The method of claim 21, wherein,
if a number of scheduled resource blocks (RBs) is an odd number, the orthonormal length is six, or
if a number of scheduled RBs is an even number, the orthonormal length is four.

23. The method of claim 21, further comprising:
receiving, from the network device, a configuration indicating:
information about at least one antenna port for the DMRS transmission, and
information about at least one CS value corresponding to the at least one antenna port.

24. The method of claim 21, wherein if a maximum number of values of the at least one CS is 6, a set of CS values is one of the following: {0, 1, 3, 4} or {0, 2, 3, 5}.

25. The method of claim 21, wherein if a maximum number of values of the at least one CS is 12, a set of CS values is one of the following: {0, 2, 6, 8} or {0, 4, 6, 10}, {0, 3, 6, 9}.

26. A method of communication, comprising:
determining, at a terminal device, at least one frequency domain orthogonal cover code (FD-OCC) for a demodulation reference signal (DMRS) transmission type 2 with more than twelve antenna ports, a length of the at least one FD-OCC being four; and
performing, with a network device, the DMRS transmission.

27. A method of communication, comprising:
receiving, at a terminal device and from a network device, a configuration for a demodulation reference signal (DMRS) transmission, indicating at least one of the following:
information about a length of FD-OCC corresponding to at least one antenna port configured for the at least one antenna port, or
information about antenna port group to be scheduled for the DMRS transmission; and
performing the DRMS transmission with a network device based on the configuration.

28. A method of communication, comprising:
determining, at a network device, at least one cyclic shift (CS) for a sounding reference signal (SRS) transmission with four antenna ports, the at least one CS comprising:
at least one first CS, corresponding to a first set of the four antenna ports or a first set of resource elements (REs) configured for the SRS transmission, and
at least one second CS, corresponding to a second set of the four antenna ports or a second set of REs configured for the SRS transmission, the at least one second CS being different from the at least one first CS; and
receiving, from a terminal device and based on the at least one first CS and the at least one second CS, the SRS transmission over a comb-structure resource with a comb value of eight.

29. The method of claim 28, wherein determining at least one CS comprises:
determining an offset value for calculating either the at least one first CS or the at least one second CS, such that the at least one second CS is different with the at least one first CS.

30. The method of claim 29, wherein the offset value is predefined or determined by the network device.

31. The method of claim 28, wherein a maximum number of values of the at least one cyclic shift is six.

32. A method of communication, comprising:
mapping, at a network device, eight antenna ports of a sounding reference signal (SRS) resource to a comb-structure resource according to a comb value of the comb-structure resource, such that:
at least two sets of resource elements (REs) based on at least two comb offset values are associated with different cyclic shifts (CSs) or different CS sets, or
at least two portions of the eight antenna ports are associated with different CSs or different CS sets; and
receiving, from a terminal device, a SRS transmission over the comb-structure resource.

33. The method of claim 32, wherein the at least two sets of REs are neighboring REs.

34. The method of claim 32, wherein a comb value of the comb-structure resource is one of the following {2, 4, 8}.

35. The method of claim 34, wherein,
a maximum number of values of the different CSs is 8 if the comb value of comb-structure resource is 2;
a maximum number of values of the different CSs is 12 if the comb value of comb-structure resource is 4; and
a maximum number of values of the different CSs is 6 if the comb value of comb-structure resource is 8.

36. The method of claim 34, wherein if the comb value of the comb-structure resource is 2, mapping the eight antenna ports comprises:
mapping a first portion of the eight antenna ports to a first set of REs based on a first comb offset, the first portion of the eight antenna ports or the first set of REs being associated with a first CS set; and
mapping a second portion of the eight antenna ports to a second set of REs based on a second comb offset, the second portion of the eight antenna ports or the second set of REs being associated with a second CS set being the same or different from the first CS set.

37. The method of claim 34, wherein if the comb value of the comb-structure resource is 2, mapping the eight antenna ports comprises:
mapping the eight antenna ports to same REs, each antenna port of the eight antenna ports being associated with a respective CS.

38. The method of claim 34, wherein if the comb value of the comb-structure resource is 4, mapping the eight antenna ports comprises:
mapping four antenna port sets of the eight antenna ports to four different sets of REs based on four respective comb offset values, wherein,
each of the four antenna port sets comprises two antenna ports; and
different antenna port sets of the four antenna port sets or different sets of REs are associated with different CS sets.

39. The method of claim 34, wherein if the comb value of the comb-structure resource is 4, mapping the eight antenna ports comprises:
mapping two antenna port sets of the eight antenna ports to two different sets of REs based on a first comb offset and a second comb offset, wherein,
each of the two antenna port sets comprises four antenna ports; and
different antenna port sets of the two antenna port sets or different sets of REs are associated with different CS sets.

40. The method of claim 34, wherein if the comb value of the comb-structure resource is 8, mapping the eight antenna ports comprises:
mapping the eight antenna ports to eight different sets of REs based on eight respective comb offset value.

41. The method of claim 34, wherein if the comb value of the comb-structure resource is 8, mapping the eight antenna ports comprises:
mapping two antenna port sets of the eight antenna ports to two different sets of REs based on the first comb offset and the second comb offset, wherein,
each of the two antenna port sets comprises four antenna ports; and
different antenna port sets of the two antenna port sets or different sets of REs are associated with different CS sets.

42. The method of claim 34, wherein if the comb value of the comb-structure resource is 8, mapping the eight antenna ports comprises:
mapping four antenna port sets of the eight antenna ports to four different sets of REs based on four respective comb offset values, wherein,
each of the four antenna port sets comprises two antenna ports; and
different antenna port sets of the four antenna port sets or different sets of REs are associated with different CS sets.

43. A method of communication, comprising:
determining, at a network device, at least one sequence of time domain orthogonal cover code (TD-OCC) for a plurality of symbols, sequences of sounding reference signal (SRS) antenna ports being used within a symbol period being the same, the symbol period corresponding to a number of orthogonal frequency division multiplexing (OFDM) symbols, wherein the number is same as a length of the TD-OCC; and
receiving, based on the determined at least one sequence of OCC, a sounding reference signal (SRS) transmission over the plurality of symbols.

44. The method of claim 43, wherein determining the at least one sequence of TD-OCC comprises:
determining the at least one sequence of TD-OCC based on at least one of the following:
the length of the TD-OCC,
a user equipment (UE) specific parameter,
a cell specific parameter, or
an interference randomization parameter for a group hopping or a sequence hopping.

45. A method of communication, comprising:
mapping, at a network device, eight antenna ports of a sounding reference signal (SRS) resource to a plurality of orthogonal frequency division multiplexing (OFDM) symbols by using at least one time domain orthogonal cover code (TD-OCC); and
receiving, from a terminal device, a SRS transmission over the plurality of OFDM symbols.

46. The method of claim 45, wherein mapping the eight antenna ports comprises:
mapping a first four antenna ports to the plurality of OFDM symbols by using a first TD-OCC; and
mapping a second four antenna ports to the plurality of OFDM symbols by using a second TD-OCC, a length of the first and the second TD-OCCs being 2.

47. The method of claim 45, wherein mapping the eight antenna ports comprises:
mapping four antenna port sets of the eight antenna ports to the plurality of OFDM symbols by using four different TD-OCCs with a length of 4, each of the four antenna port sets comprising two antenna ports.

48. A method of communication, comprising:
determining, at a network device, at least one cyclic shift (CS) for a demodulation reference signal (DMRS) transmission type 1 with more than eight antenna ports, four CSs of the at least one CS being orthonormal to each other with a minimum orthonormal length of four or six; and
performing, with a terminal device, the DMRS transmission.

49. The method of claim 48, wherein,
if a number of scheduled resource blocks (RBs) is an odd number, the orthonormal length is six, or
if a number of scheduled RBs is an even number, the orthonormal length is four.

50. The method of claim 48, further comprising:
transmitting, to the terminal device, a configuration indicating:
information about at least one antenna port for the DMRS transmission, and
information about at least one CS value corresponding to the at least one antenna port.

51. The method of claim 49, wherein if a maximum number of values of the at least one CS is 6, a set of CS values is one of the following: {0, 1, 3, 4} or {0, 2, 3, 5}.

52. The method of claim 21, wherein if a maximum number of values of the at least one CS is 12, a set of CS values is one of the following: {0, 2, 6, 8} or {0, 4, 6, 10}, {0, 3, 6, 9}.

53. A method of communication, comprising:
determining, at a network device, at least one frequency domain orthogonal cover code (FD-OCC) for a demodulation reference signal (DMRS) transmission type 2 with more than twelve antenna ports, a length of the at least one FD-OCC being four; and
performing, with a terminal device, the DMRS transmission.

54. A method of communication, comprising:
transmitting, at a network device and to a terminal device, a configuration for a demodulation reference signal (DMRS) transmission, indicating at least one of the following:
information about a length of FD-OCC corresponding to at least one antenna port configured for the at least one antenna port, or
information about antenna port group to be scheduled for the DMRS transmission; and
performing, the DRMS transmission with a terminal device based on the configuration.

55. A terminal device comprising:
a processor; and
a memory coupled to the processor and storing instructions thereon, the instructions, when executed by the processor, causing the terminal to perform the method according to any of claims 1-27.

56. A network device comprising:
a processor; and
a memory coupled to the processor and storing instructions thereon, the instructions, when executed by the processor, causing the device to perform the method according to any of claims 28-54.

57. A computer readable medium having instructions stored thereon, the instructions, when executed on at least one processor, causing the at least one processor to perform the method according to any of claims 1-54.
